(19) United States
(12) Patent Application Publication
(10) Pub. No.: US 2025/0254416 A1
(43) Pub. Date: Aug. 7, 2025

(54) ENHANCED VIDEO SUPPORT

(71) Applicant: 8x8, Inc., Campbell, CA (US)

(72) Inventors: Emil IVOV, Campbell, CA (US); Hunter Middleton, Campbell, CA (US); Lisa Orford, Campbell, CA (US); Tiberiu Ilisescu, Campbell, CA (US); Horatiu Muresan, Campbell, CA (US)

(73) Assignee: 8x8, Inc., Campbell, CA (US)

(21) Appl. No.: 19/044,170

(22) Filed: Feb. 3, 2025

Related U.S. Application Data
(60) Provisional application No. 63/549,063, filed on Feb. 2, 2024.

(51) Int. Cl. H04N 23/62; H04M 3/51; H04N 23/60; H04N 23/695

(52) U.S. Cl. CPC H04N 23/62; H04N 23/64; H04N 23/695; H04M 3/5166; H04M 3/5183

(57) ABSTRACT

One or more methods, device, and/or systems may perform a video elevation. In a non-limiting example, a communication platform performs a video elevation including transitioning a communication from a first state (e.g., using an existing communication channel) to a second date, such as a video call. The communication may be between an end user device (e.g., customer needing support) and an agent device (e.g., agent providing support), where the functionality at each device and respective graphical user interfaces (GUIs) may be provided by the platform. The platform may enable the agent device to control the end user's device (e.g., camera) through the GUI. Additionally, the platform may capture annotation information related to objects visible via the camera, based on actions taken by the agent through the GUI while controlling the camera. Additional artificial intelligence insights may be provided by the platform based on historic or real-time data.

### CROSS-REFERENCE TO RELATED APPLICATIONS

This application claims the benefit of U.S. Provisional Application No. 63/549,063, filed Feb. 2, 2024, the contents of which are incorporated herein by reference.

### BACKGROUND

Call center technology has evolved significantly over the decades, transforming from simple phone-based operations to sophisticated cloud based systems. In the early days, call centers relied on Private Branch Exchange (PBX) systems, which allowed businesses to route calls internally. In the 1980s and 1990s, Interactive Voice Response (IVR) and Automatic Call Distribution (ACD) systems improved efficiency by directing callers to appropriate agents. The 2000s saw the rise of cloud-based solutions. As the technology has advanced, the need for enhancing the experience has also increased.

### SUMMARY

One or more methods, device, and/or systems may perform a video elevation. In a non-limiting example, a communication platform performs a video elevation including transitioning a communication from a first state (e.g., using an existing communication channel) to a second date, such as a video call. The communication may be between an end user device (e.g., customer needing support) and an agent device (e.g., agent providing support), where the functionality at each device and respective graphical user interfaces (GUIs) may be provided by the platform. The platform may enable the agent device to control the end user's device (e.g., camera) through the GUI. Additionally, the platform may capture annotation information related to objects visible via the camera, based on actions taken by the agent through the GUI while controlling the camera. Additional artificial intelligence insights may be provided by the platform based on historic or real-time data.

### BRIEF DESCRIPTION OF THE DRAWINGS

The following detailed description may be better understood in view of the figures, where like reference numerals in the figures indicate like elements, and wherein:

FIG. 1A illustrates an example of a data-communications system, as may be implemented in accordance with one or more aspects of the disclosure.

FIG. 1B illustrates an example of a data-communications system that is related to the system shown in FIG. 1A.

FIG. 1C illustrates an example of a data-flow diagram that may be implemented at least in part by one or more components of the communications system depicted through FIGS. 1A and 1B.

FIG. 2 illustrates an example of a data-communications system having aspects that may be implemented in accordance with one or more embodiments disclosed herein.

FIG. 3 illustrates an example screen of a GUI for a communications platform initiating a video elevation.

FIG. 4 illustrates an example screen of a GUI for a communications platform with an initiation message.

FIG. 5 illustrates an example screen of a GUI for a communications platform with video engagement beginning.

FIG. 6 illustrates an example screen of a customer device with an invitation for video engagement.

FIG. 7 illustrates an example screen of a customer device concerning permissions for video engagement.

FIG. 8 illustrates an example screen of a GUI for a communications platform with active video engagement and an example screen of a customer device with active video engagement.

FIG. 9 illustrates an example screen of a GUI for a communications platform with active video engagement and on-screen insights.

FIG. 10 illustrates an example screen of a GUI for a communications platform with engagement and on-screen insights.

FIG. 11 illustrates an example screen of a GUI for a communications platform concerning external linking.

FIG. 12 illustrates an example screen of a GUI for a communications platform ending video engagement.

FIG. 13 illustrates an example screen of a GUI for a communications platform integrating with CRM at the end of a meeting.

FIG. 14 illustrates an example screen portion of a GUI for a communications platform integrating with CRM.

FIG. 15 illustrates an example screen of a GUI for a communications platform with engagement report.

FIG. 16 illustrates an example screen of a GUI for a communications platform with an analytics report.

FIG. 17 illustrates an example screen of a GUI for a communications platform with annotations.

FIG. 18 is an example of a computer.

FIG. 19 illustrates an example of a network architecture of a communications platform.

FIG. 20 illustrates an example of a video elevation process.

### DETAILED DESCRIPTION

Non-limiting examples of the present disclosure may be implementable as processing improvements for stand-alone applications or services, which can also be integrated into software computing platforms (“software platforms”). As software data platforms have layers of complexity, technical problems identified herein can be amplified in such implementations which further illustrates the technical advantages presented in the present disclosure. As such, some examples of the present disclosure may be provided in connection with a software platform such as a software communications platform. An exemplary software communications platform provides digital tools and services that enable real-time (or near real-time) information sharing and collaboration amongst users. An example of a software communications platform may be a cloud-based communications platform (cloud-based platform implementation) such as 8×8 Work® made available by 8×8, Inc. (e.g., additional supporting documentation available at http://www.8×8.com), among other examples.

The present disclosure is implementable to adapt and improve not only back-end data processing of a software platform (e.g., software communications platform) but also front-end representations to users provided through a software platform providing further tangible evidence of the technical benefits of the present disclosure. For instance, this can be accomplished through data processing management for computer hardware and software that is configured to provide exemplary video elevation functionality described herein. Exemplary video elevation as described herein is intended to cover multiple aspects, separately or collectively, whereby video elevation is utilized to transform a state of an existing electronic communication into a video call or electronic meeting while also providing an adapted user experience, including feature functionality controls, and data insights, tailored to an elevated video experience and interaction between end users. For ease of explanation, a non-limiting example of a user interaction may be an end customer (end user) and an agent (support agent) providing support to the end customer for products or services. As a non-limiting example of a communication means, the end user and the agent may be utilizing a software communications platform that enables the end user and the agent to connect through a plurality of different communication channels, including those that may not initially include an electronic video communication (or electronic meeting) between agents and end customers. User interactions often need to be escalated, especially when agents and end customers need to interact, but traditional communications systems are piecemeal and do not provide an integrated, cohesive and extensible solution to streamline matter escalation, manage an existing interaction (e.g., an ongoing video call), facilitate improved means for data collection retention, and augmentation, and management post-meeting activities including ongoing business relationships, follow-up actions, recommendations, etc.

An exemplary software communications platform may include any technology described herein as “cloud-based platform implementation” individually or collectively. In one example, an exemplary software communications platform may comprise but is not limited to a combination of UCaaS, CPaaS, CPaaS features and functionalities, web services, and connected websites, administrative portals/consoles, connected to system infrastructure including phone systems hosted remotely by servers and accessible via the internet. An exemplary software communications platform can uniquely generate and manage contextual data from components and users thereof, which can then be leveraged cross-platform and further with third-party integrations services, platforms, (e.g., including integrations via API) to provide a rich and contextual omni-channel user experience (e.g., across a plurality of communication channels including voice, electronic meetings, chat, email, messaging, digital messaging, social media) that is accessible through an adapted GUI. An adapted GUI of a software communications platform may be configured and presented as a single unified workspace but can also be represented in via a plurality of GUI workspaces, collapsible and expandable, including break-out GUI functionality to help manage control over communications across different communication channels (omni-channel). Non-limiting examples of features and functionalities of an exemplary software communications platform comprise: omni-channel communication functionality; bot integrations including conversational chatbots (including AI/ML integrations); workforce management (e.g., supervisory management of users such as agents, enterprise resource planning); data analytics (including user-specific, device-specific, software service-specific such as UCaaS or CCaaS, and/or aggregated); ML/AI integrations for data processing, analysis and augmentation including query/response capabilities, translation, transcription, summarization, sentiment and/or biometric analysis, data insight generation, and generation of recommendations or automation of actions within platform; reporting/report generation; customer relationship management (CRM) tools; device management (e.g., phones including both physical phone devices and softphones, PBX, phone numbers, porting, etc.); issue management including support and help desk ticketing management; transaction processing (including payment transactions); billing management; administrative management control including administrative console apps/services to enablement management of users via user profiles, device profiles; phone systems; works groups, ring groups, call queues, group paging, overhead paging, barge-monitor-whisper); IVR; call routing and distribution; call recording functionality; data storage (e.g., including control over hot and cold storage); phone dialers; conversation management including messaging via chat (individual and group), SMS/MMS, including messaging campaigns, website management, and management of service availability, among other examples.

Non-limiting examples of the present disclosure include systems and methods for enhancing electronic communications through implementation of video elevation services in a software communications platform. As indicated, video elevation as described herein covers multiple aspects, separately or collectively, whereby video elevation is utilized to transform a state of an existing electronic communication into a video call or electronic meeting while also providing an adapted user experience, including feature functionality controls, and data insights, tailored to an elevated video experience and interaction between end users. A video elevation request may be sent to one or more users through a software communications platform. In some instances, a user (e.g., agent/support agent for an organization such as a business) may execute an action through the software communications platform (or a communication channel thereof) to initiate sending of the video elevation request through a service of the software communications platform, for example, by selecting a graphical user interface (GUI) feature configured to initiate a video call or electronic meeting with one or more other users (e.g., end customers). In other instances, a software communications platform may be configured to further enable an end user (e.g., end customer) to initiate a video elevation experience through a GUI of the software communications platform. Some initial communication states between end users and agents may not require video functionality or alternatively an electronic communication may otherwise start via a communication channel that does not have (or require) video functionality activated. Consider an example where an electronic communication is being conducted between an end user device and an agent (support agent) device via a communication channel of a software communications platform. An exemplary video elevation request may be configured to transfer an electronic communication of a software communications platform, between an end user device and an agent device, from a first (communication) state to a second (communication) state being a video call executed via the software communications platform. For instance, a first state (e.g., first communication channel) of an electronic communication may be voice call between an end user device and an agent device. In another example, a first state of an electronic communication is one of an electronic chat, an electronic message, or an email, for example, between an end user device and an agent device. In any instance, an electronic communication may be elevated to a second communication state (e.g., second communication channel) that comprises video functionality (e.g., a video call or electronic meeting).

Based on receipt of the video elevation request, a software communications platform may be configured to launch a video call (or other communication channel that includes video functionality) between the end user device(s) and the agent device(s). A representation of the video call may be presented through a GUI of the software communications platform. In some examples, the representation may be presented through a main GUI window of an application/service or alternatively a segmented GUI portion or pop-out window of an application/service included in the software communications platform) and/or additionally/alternatively sent to a specific application/service instance of the software communications platform (e.g., desktop version, mobile version and/or specific devices associated with such versions) where a GUI instance may be then be launched. An agent device may be provided with control over a camera of an end user device via GUI control elements provided via the representation of the video call which is presented through the GUI of the software communications platform. While an end user device and agent device are engaged in (or prior to) the video call, a permission request may be transmitted to the end user device to enable the end user device to accept a permission for the agent device to control the camera during the video call. In response to receiving acceptance of the permission, a view from the camera in the representation of the video call may be displayed, and GUI feature functional (e.g., GUI control elements) may be activated comprising GUI control elements adapted to enable to control the camera of the user device, capture images, videos, etc., and collect pertinent data for electronic communication and beyond (e.g., follow-up actions, ongoing communications statuses, etc.). For instance, a viewable display, via the camera of the end user device, may be provided through the representation of video meeting so the agent device (and other users/participants) can see the view from the user's camera including one or more objects that are presented within the view. GUI control elements are configured to enable panning of a viewable area of the camera including the one or more objects, and wherein the capturing further comprises receiving data indicating a selection of one or more GUI control elements for adjusting an angle and/or a direction of a view of the camera relative to the one or more objects. The GUI control elements further comprise GUI elements control configured to enable the agent device, via the representation of the video call, to generate one or more of: a screenshot of the one or more objects, a video clip of the one or more objects; a description tag (or notes) for the one or more objects, and a geo-locational marker for the one or more objects, among other examples.

Continuing the one or more examples described herein, annotation information for the one or more objects viewed from the camera may be captured via the representation of the video call presented via the GUI of the software communications platform. Exemplary annotation information may be captured based on receipt of one or more actions initiated by the agent device which are received via the GUI of the software communications platform while the agent device has control over the camera of the end user device. Optionally, GUI control elements may be presented to enable the agent device and the end user device to toggle control of the camera between users during the video call, which may improve efficiency in information gathering in some cases. As guiding actions may be received from an agent device, capture of the annotation information comprises receiving data indicating a selection of one or more GUI control elements by the agent device in the representation of the video call, and generating the annotation information based on an analysis of the data indicating the selection of the one or more GUI control elements by the agent device.

Moreover, video elevation as described herein may further be enhanced through generation, training, adaptation, and application of artificial intelligence (AI)/machine learning (ML) modeling in numerous different instances. Connecting Al/ML modeling to expansive data sets and endpoints of a software communications platform creates practical applications that not only improve the processing efficiency of communications software platform through data collection, retention, and creation/augmentation (including creation of data insights), but further improve user experience and processing efficiency of resolving support issues between end users and agents, among other advantages.

In some examples, one or more trained artificial intelligence models may be adapted to generate (and in some instances automatically capture) the annotation information based on at least the receipt of one or more actions initiated by the agent device, during the video call, via the GUI of the software communications platform. In further examples, AI modeling may be further trained to evaluate additional contextual information provided via the software communications platform to generate the annotation information, and wherein the additional contextual information comprises a transcription of the video call between the end user and the agent, and/or historical contextual information from previous use of the communications software platform by an end user entity associated with the end user device. This can enable richer contextual information for an electronic communication and beyond (e.g., follow-up actions, reporting, recommendations, etc.) In other examples, one or more trained artificial intelligence models to generate (and provide) one or more data insights for the agent device, including suggestions for capture of the annotation information. Among other things, this may enable an agent, via an agent device, to execute autonomy over the information being captured but quickly and efficiently confirm/capture important data in a timely manner, which is extremely important in a customer interaction, especially one where the customer is having technical issues. In one example, data insights may be provided to the agent device via the representation of the video call. However, because a software communications platform enables omni-channel communications, data insights may be sent directly to the agent device via another communication channel/modality such as chat, email, messaging (e.g., SMS messaging), etc. To generate the one or more data insights, one or more trained artificial intelligence models are trained to analyze receipt of action initiated by the agent device during the video call, and additional contextual information comprising one or more of: a transcription of the video call between the end user device and the agent device, and historical contextual information from previous use of the communications software platform by an end user entity associated with the end user device, and wherein the receiving of the data indicating a selection of one or more GUI control elements by the agent device occurs after the data insights are provided to the agent device. In even further examples, AI modeling may be created, trained, adapted, and applied to provide data insights, actions, recommendations, etc. after the conclusion video call so that a business relationship can be properly managed with an end user and its entity/business.

Non-limiting examples of technical advantages provided based on the one or more techniques described herein, may include, but are not limited to: provision of video elevation functionality to enhance electronic communications through application/services including in software communication platforms, improve data orchestration, data creation, augmentation, collection, retention, for managing data of an electronic communication across a plurality of communication channels of a software communications platform; improved processing efficiency (e.g., reduction in processing cycles, saving resources/bandwidth) for computing devices managing electronic communications and corresponding data, reduction in latency of computing devices supporting software platforms which can include reduction in latency for back-end computing processing and resulting front-end output during execution of a software platform (e.g., software communications platform); creation, training, and adaptation of AI modeling integrated within applications/services for processing improvement across a variety of practical of applications described herein including and data correlation, creation (e.g., generation of contextual data insights and suggestions for agents and/or end users) and retrieval; an improved GUI adapted to enable customized permission request management and remote control of end user camera devices during an electronic communication (e.g., a video call or electronic meeting) as well as surfacing of contextually relevant data insights, suggestions, etc. for agent devices and/or end user devices; and improved usability (user experience) of host applications/services and software platforms (e.g., software communications platforms) that integration video elevation functionality, among other technical advantages.

One or more aspects of the present disclosure may be carried out, orchestrated, performed, executed, managed, handled, and/or run by a communications platform. One or more aspects of the present disclosure may be carried out in connection with any of various types of communications systems, via the communications platform, providing data-communications services. The communications platform may host, facilitate, connect to, embed, operate, run, be a part of, be in control of, include, and/or the like with one or more components, modules, features, functions, services, etc., such as unified communications (e.g., unified communications as a service, ‘UCaaS’), contact center communications (e.g., contact center as a service, “CCaaS”), communications platform as a service (“CPaaS”), for example, enabling usage of application programming interfaces (APIs) and the like to customize communication stacks and integrate chosen communication channels into applications, services, websites, etc., and/or a combination thereof (e.g., providing a platform which may be referred to as XCaaS (Experience Communications as a Service). In one case, communications platform may be software. In one case, communications platform may be software and hardware. In one case, communications platform may be hardware.

Various example embodiments, including experimental examples, may be understood in consideration of the description disclosed herein and/or in connection with the accompanying figures.

While various embodiments, examples, aspects, solutions, and/or techniques discussed herein may be modified to alternative forms, aspects thereof have been shown by way of example in the drawings and will be described in detail herein. It should be understood, however, that the intention is not to limit the disclosure to the particular example described. On the contrary, the intention is to cover all modifications, equivalents, and alternatives falling within the scope of the disclosure including aspects defined in the claims. In addition, the term “example” as used throughout this application is only by way of illustration, and not limitation.

Various aspects and examples according to the present disclosure are directed to issues such as those addressed herein and/or others that may become apparent from the description provided herein involving various methods and systems in which an enhanced video experience is realized through a communications platform.

As used herein, reference to a “user entity”, “client entity” or “user” may refer to an individual (human) operating a computer-based device, or embedded electronics operating to access a computer-based system and/or data. Embedded electronics may be provided in phones, computers, attached devices, home networks, printers, vehicles and other systems. Providing or granting access may involve providing access to a computer system, providing access to data controlled by a system, providing access to modify data or programming, and access to cloud-based data, as non-limiting examples. In one instance, a user may be a computer-generated (CG) user, operating as a subsystem of a larger system, to act independently and/or in concert with another system. For example, in at least one scenario, reference to an agent user herein may be an AI/ML model with the goal of solving a problem of a customer. Such a CG user may have specific access and control.

While examples are referenced herein in the form of systems, features and/or methods, such discussion is for providing merely an exemplary context to help explain such aspects, and the present disclosure is not necessarily so limited. The examples and specific applications disclosed herein may be implemented in connection with one or more aspects, examples (or example embodiments) and/or implementations, whether such aspects are considered alone or in combination with one another.

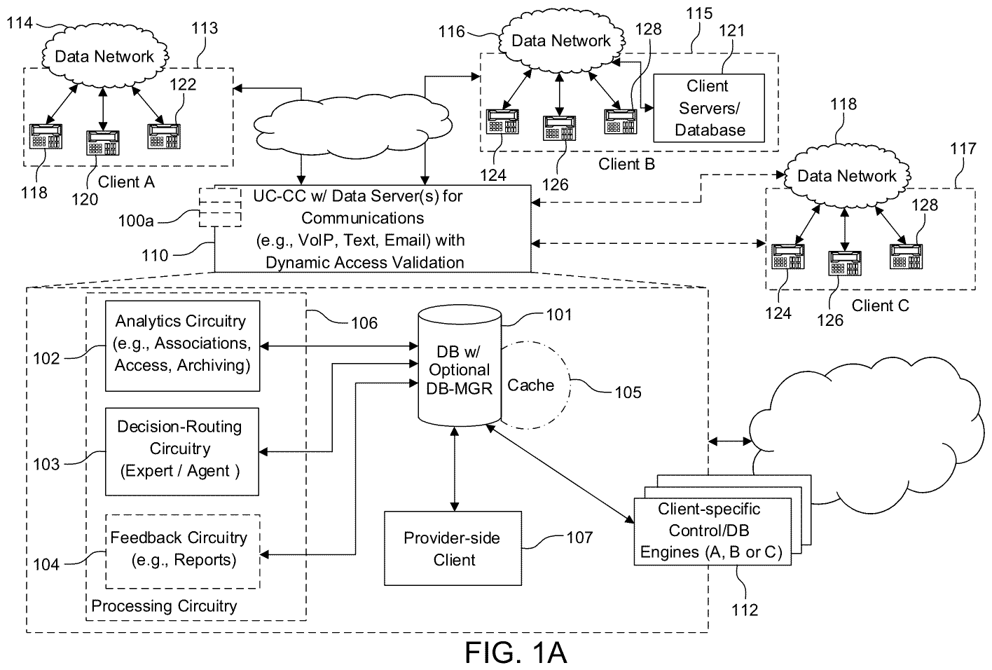

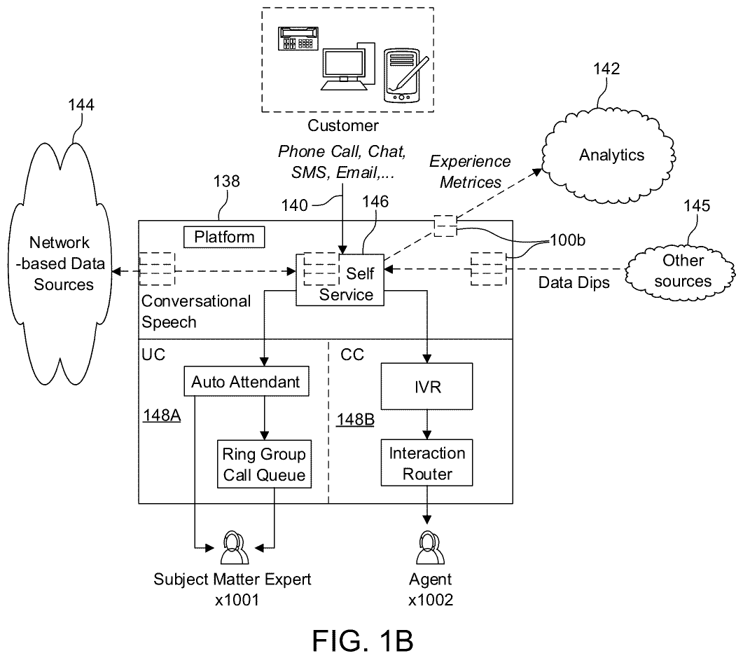

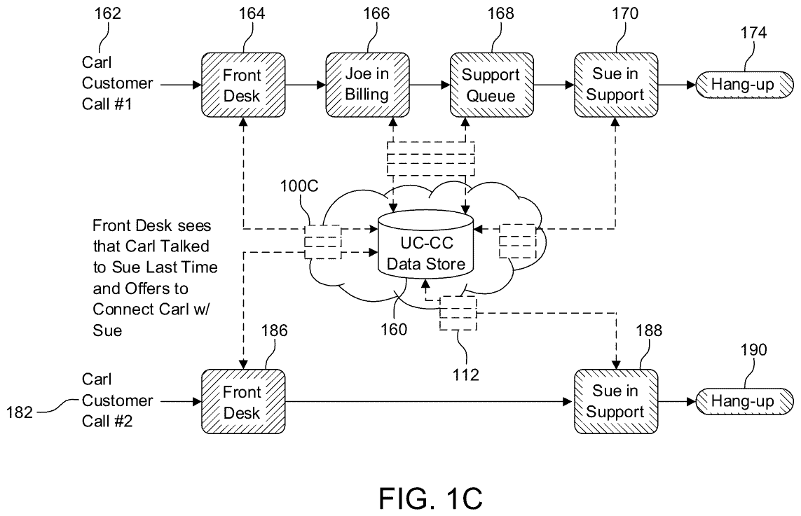

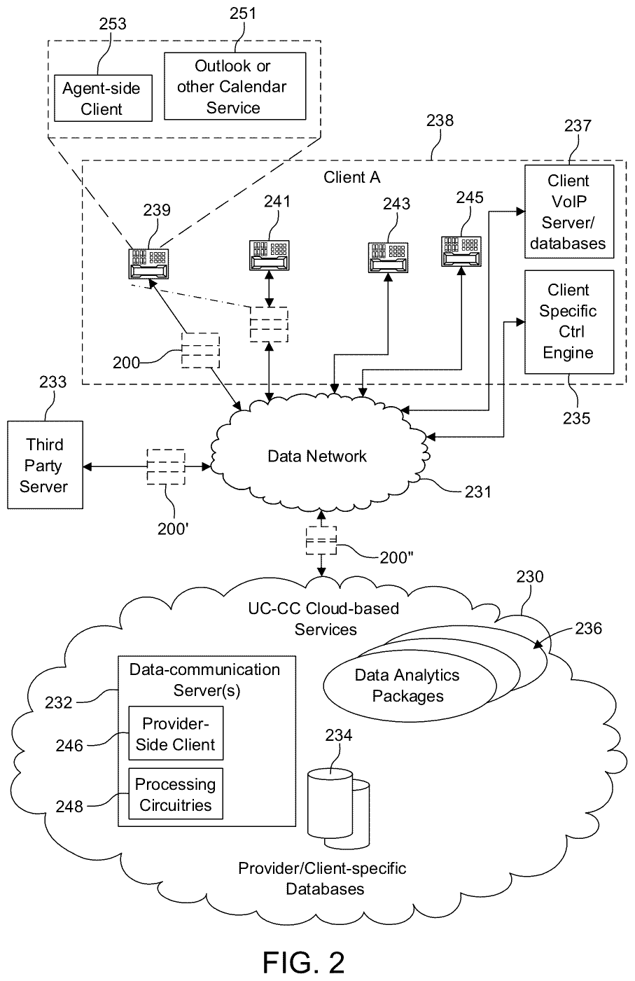

FIG. 1A illustrates an example of a data-communications system, as may be implemented in accordance with one or more aspects of the disclosure. FIG. 1B illustrates an example of a data-communications system that is related to the system shown in FIG. 1A. FIG. 1C illustrates an example of a data-flow diagram that may be implemented at least in part by one or more components of the communications system depicted through FIGS. 1A and 1B. FIG. 2 illustrates an example of a data-communications system having aspects that may be implemented in accordance with one or more embodiments disclosed herein.

One or more of the aspects, systems, methods, etc., characterized herein may be used by adapting a system, such as shown in the following FIGS. 1A, 1B and 1C, and in FIG. 2. These figures are presented to depict certain example implementations, according to the present disclosure, in which one or more of the described aspects may be implemented and used. In each such illustrated example, a data communications server system provides data-communications services including, as examples, VoIP, virtual office features (e.g., communications) via a contact-center such as exemplified by the assignee of the present disclosure (8×8, Inc.® as indicated at www.8×8.com) and as characterized in one or more of the figures included as part of the present disclosure).

As may be apparent, external access to the data-communications system (whether the system at large, or one of the system's pieces such as its server(s), databases, computer-processing circuitry, etc.) is dynamically checked so as to maintain ongoing validation that the access and/or user (effecting/attempting the data access effort) is appropriate. Such approaches may involve generating and updating a persistent fidelity score for user entities accessing the system, as characterized herein. For instance, a persistent fidelity score concerning characteristics associated with a user entity accessing data/systems (e.g., 101) from an endpoint device such as 118 may be maintained by generating the fidelity score and subsequently updating the fidelity score based on activity of the user entity over a time period during which the user entity accesses the data/systems. The fidelity score generation and updating may be carried out at analytics circuitry 102, and used to selectively grant or deny continued access to the data/systems during the time period, in response to the updated fidelity score being within a threshold tolerance and based on the characteristics associated with the user entity.

To illustrate one of more of the aspects described herein, each of FIGS. 1A, 1B and 1C includes a block in dashed lines in the data-communications pathway between the external node (e.g., data-processing-computer circuit sometimes including IP-communications enabled circuitry) or a point of (attempted) data access in the data-communications system. For example, in FIG. 1A, such a block is depicted in multiple instances in each of FIG. 1A, 1B and 1C, respectively as 100a, 100b and 100c (and in FIG. 2, as 200, 200′ and 200″). In each such figure, the circuit-based blocks appears in more than one instance but it is appreciated that the one or more of these circuit-based blocks may be implemented and where multiple are implemented, such circuit-based blocks may be implemented as separate blocks or as one or more integrated/structurally-unified blocks; and one or more of these circuit-based blocks may be managed/controlled substantially independently a stand-alone (master) circuit or as a functionally-dependent (slave) circuit which is subservient to control of another circuit (e.g., circuitry as part of a user interface, one or more servers, etc.).

In connection with the following FIGS. 1A, 1B and 1C, various aspects described herein may be recognized as corresponding to one or examples herein including, but not limited to: from FIG. 1A, service-provider data servers corresponding to 110, databases corresponding to 101, 112 and 121, broadband network(s) corresponding to each cloud such as 118, and AI/ML engine(s) corresponding to analytics circuitry 102; and from FIG. 1B, AI/ML engine(s) corresponding to analytics circuitry 142 which may be part of the data-provider system platform and/or circuitry operated on behalf of a third party (e.g., big-data services company), a live receptionist-based and/or automated client-specific call center as corresponding to one or both of 148A and 148B (the latter operating in an integrated manner). It will also be appreciated that aggregating data and different contexts of such data, as described in connection with these figures, may be part of the data augmentation and development of the database(s).

FIG. 1A illustrates one such example data-communications system in block diagram form and consistent with certain of the examples and aspects of the present disclosure. As shown in FIG. 1A, the data-communications system includes a data-communications server 110 configured to provide data communication services, including data communications such as VoIP calls and other types of interactions (e.g., text, chat, email, etc.), for a plurality of endpoint devices 118, 120, 122, 124, 126, 128 connected in one or more data networks 114, 116. In more specific embodiments, the data-communications server 110 includes an arrangement of coordinated servers such as one or more VoIP communications servers that provide VoIP communications and one or more other types of communications servers that provide such other forms of data communications service(s). Although FIG. 1A illustrates two data networks 114, 116 communicatively coupled to the data-communications server 110, examples are not so limited and the data-communications server 110 may be communicatively coupled to three or more data networks, including as examples but not limited to broadband networks such as the Internet, cellular-telephony and/or satellite communications networks, etc. Such networks and communicatively-coupled endpoint devices are configured to communicate with one another (directly and/or indirectly) using data-communications circuits which are typically wireless transceivers with user interfaces (e.g., graphic user interfaces, audible, etc.). For purposes of facilitating discussion, various specific embodiments are herein directed to methods and apparatuses that include the data-communications server 110 and processing circuitry 106 in one or more of the noted variety of forms. Although the processing circuitry 106 is illustrated as a component of the data-communications server 110, embodiments are not so limited and the processing circuitry may form part of or be separate from the data-communications server 110.

The endpoint devices are circuit-based instruments that may be used by personnel (or users) and include data communications-enabled circuitry, such as VoIP-enabled endpoint devices (e.g., IP phones, smart phones, tablets, and/or desktop computers with appropriate VoIP software applications) and/or non-data communication/VoIP enabled endpoint devices (e.g., plain old telephone service (POTS) telephones and cellular-capable devices). Each endpoint device may be respectively associated with an account of a respective client. Endpoint devices may be associated with a particular client account by registering the endpoint device with a particular client account serviced by the data-communications server 110. Registered devices for each client account may be listed in a respective account settings file (not shown) stored by the data-communications server 110. In this example, endpoint devices 118, 120, and 122 are associated with an account 113 for a first client A and endpoint devices 124, 126, 128 are associated with an account 115 for a second client B. In such a manner, a plurality of endpoint devices may each be serviced by the data-communications server 110 in accordance with aspects of the present disclosure. One or more of the clients may have client servers and/or databases 121 used to implement a variety of different services.

Accordingly, the endpoint devices are data-communications circuits which may be remotely located relative to the data-communications server 110 and may be respectively associated with remotely-situated client entities. In certain but not all embodiments, the data-communications system may include the remotely-located data-communications circuits, and in some instances one or more of the endpoint devices correspond to and/or includes a computer or a smartphone (e.g., mobile phone or tablet) to function as a softphone by running application software; and/or a computer or a smartphone to operate natively within a web browser (e.g., using webRTC) and in turn the web browser is to run on a computer or a smartphone.

The system may include one or more processing circuits configured to implement client-specific control engines 112, which are configured to adjust the data-communications provided for each client account according to a respective set of control directives. For instance, the client-specific control engines 112 may adjust routing of an incoming interaction (e.g., a VoIP-type data or text communication) to or from a client account by generating client-specific sets of control data to the data-communications server 110.

In certain embodiments, the client-specific control engines 112 are implemented in various locations. For example, client-specific control engines 112 for one or more client accounts may be implemented in a central server connected to, or incorporated with, the data-communications server(s) 110. Additionally or alternatively, one or more client-specific control engines 112 may be implemented by one or more processing circuits maintained by the client including, for example, database circuit 101 which may include a database manager such as the described type. Similarly, the control directives may be stored locally within the client-specific control engines, or stored remotely (e.g., in a centralized database, in a database maintained by the client or a combination thereof). In certain specific examples, the database manager circuit (or database 101) refers to or includes a relational database management system (RDMS) which stores data securely and returns the data in response to requests from other applications, as implemented by a database management server, and which may temporarily store data in cache 105.

In one specific example, the form of the system shown in FIG. 1A includes the data-communications server 110 configured as a unified-communications and call center (UC-CC) platform that processes incoming data-communication interactions including different types of digitally-represented communications (e.g., text, chat, email, etc.). A UC-CC platform is described for convenience of explanation but is just a non-limiting example of a configuration of a software communications platform. The platform is integrated with a memory (database) circuit 101 (optionally with cache memory 105 for quick access to high-priority calls or calls requiring relatively significant analysis and processing). The memory circuit includes database having a plurality or a plethora of information sets. Each of the information sets includes user/client-entity contact information and/or experience data corresponding to past incoming data-communication interactions processed by the platform, and with the information sets being populated via an aggregation of organized data based on data collected in previous incoming interactions. The platform regularly accesses the database to assess the incoming interactions and may use past incoming interactions along with information collected via other data sources (e.g., internal to the system such as AI/ML modeled data and/or 3rd party information). By analyzing the incoming interactions and accessing possible associations relative to the information sets in the memory circuit 101; the platform is able to facilitate an automated self-service experience for users by resolving inquiries discerned through the incoming interactions and/or effecting call-decision routing of incoming interactions to call-center agents or specialists.

Such automated self-service experiences provided via the data-communications server 110 of FIG. 1A may be realized by the processing circuitry 106 including various circuits (e.g., servers, software-directed aspects of CPU(s), logic circuitries, etc.) such as having analytics circuitry 102 to analyze an incoming interaction relative to content in the database 101 and/or to AI/ML models (not shown in FIG. 1A), having decision-routing circuitry 103 for deciding whether and/or how an incoming interaction should be routed, and in certain more specific examples or applications also having feedback circuitry 104. In specific embodiments, the data-communications server 110 may use the analytics circuitry 102 to analyze an incoming interaction by capturing and analyzing digital voice data from spoken conversations in connection with incoming interactions such as between agents of a client entity and customers. The spoken conversations may be transcribed from audio to digital voice data by the data-communications server 110, the endpoint device of the agent via a client on the endpoint device, and/or client data-communications server. The transcription of the spoken audio words to digital voice data may occur via a variety of methods. By discerning the contact information and/or other content (e.g., context of call and/or the transcription), the decision-routing circuitry 103 may access the information sets so as to check for associations and, if certain associations relevant to the current (e.g., live) call, the call may be routed as indicated by an associated one of the information sets, by user/client-entity profile settings stored with or linked to the associated one of the information sets, and/or based on a metric indicating sufficient confidence that the routing the call to a specific designation (e.g., to an expert such as a specialist having been training or otherwise having special knowledge regarding topic discerned from the call, or to an agent/manager who is assigned to the topic or incoming interaction), and each such decision may be discerned by accessing and analyzing the information sets.

Further aspects and example (optional) responsibilities of these circuitries 102, 103 and 104 are discussed further herein, for example, in connection with related examples such as an example block diagram shown in FIG. 1B, an example application shown in FIG. 1C, and in connection with example manners in which incoming interactions (calls) may flow as in the other example systems disclosed herein.

In various embodiments, the data-communications system may also track a variety of information, parameters and/or metrics related to calls (i.e., incoming interactions) made or received by the agents of a client entity via processing circuitry 106 that is communicatively coupled to the data-communications server 110. The parameters may include information such as average call duration, compliance of call opening and account information, identification of issues and troubleshooting, resolution, professionalism, and other metrics. The parameters may be scored (e.g., percentage or other value scored) to rate the particular agent on each particular call and to form a metric used to assess an agent. In some embodiments, the parameters and/or metrics may be assessed automatically by the system using keywords. In other embodiments and/or in addition, the calls are recorded and may be replayed for a person to score (or update an automatic score) on the metrics. The parameters and/or metrics may be used to determine an outcome of the call. For example, the resolution may be indicative of the outcome. The scores may be reviewed upon recording the calls which may be reviewed by a reviewer. For example, the reviewer may listen to the call recording while a user interface is displayed on a computing device associated with the reviewer. The user interface displayed may illustrate a timeline of the recorded call, which may show timing of the current voice data being played. The timeline may allow the reviewer to navigate within the call by selecting portions of the timeline to change what the reviewer is listening to. Additionally, the agent and the customer may have different waveforms for efficient reviewing. In other embodiments, other types of analysis are used, as further described herein.

In a number of embodiments, a particular client may customize the metrics that are to be tracked such as by the server 110 of FIG. 1A. Such customization may include the type of metrics, values given, and/or particular phrases or statements for complying with the metric (e.g., a specific call opening). For example, the customization may include definitions of performance expectations and scores, as well as performance thresholds for various metrics.

In a number of embodiments, a particular client may customize the metrics that are tracked. Such customization may include the type of metrics, values given, and/or particular phrases or statements for complying with the metric (e.g., a specific call opening). For example, the customization may include definitions of performance expectations and scores, as well as performance thresholds for various metrics.

As described, client-specific control engines may be used to facilitate adjustment of a variety of remote services including, for example, data-communication services such as VoIP calls, audio and/or video conferencing, general private branch exchange services, packet switching, chat, and traffic management as well as non-VoIP services including, but not limited to, website hosting, remote data storage, remote computing services, and virtual computing environments. One or more of such services may be provided, for example, by a cloud computing network having one or more servers configurable for a plurality of clients.

As may be appreciated, audio from an incoming interaction (e.g., incoming VoIP and/or video call) may be transcribed to text using a variety of techniques. As an example, an audio file may be generated and provided to speech recognition circuitry, which may be part of the endpoint device, the data-communications server 110, or other external circuitry. The audio file, which includes an acoustic signal received by a microphone of the endpoint, is converted or transcribed to text (e.g., a set of text words) by the speech recognition circuitry. In various embodiments, the speech recognition circuitry may use a voice model and/or database of words for converting or transcribing the audio to text. For example, the speech recognition circuitry may index the words in the audio file to identify words or phrases, such as using an extensible markup langue (XML), structured query language (SGL), mySQL, idx, and other database language. For more general and specific teachings on transcribing audio to test, reference is made to U.S. Publication No. 2009/0276215, filed on Apr. 17, 2007, entitled “Methods and Systems for Correcting Transcribed Audio Files;” U.S. Pat. No. 7,236,932, filed Sep. 12, 2000, entitled “Method of and Apparatus for Improving Productivity of Human Reviewers of Automatically Transcribed Documents by Media Conversion Systems;” and U.S. Pat. No. 6,424,935, filed Jul. 31, 2000, entitled “Two-way Speech Recognition and Dialect System,” each of which are fully incorporated by reference for their teachings.

As illustrated in FIG. 1A, the data-communications server 110 interfaces with a plurality of remotely-situated client entities and includes or is otherwise in communication with processing circuitry 106. The processing circuitry 106 may receive digital voice data indicative of transcribed audio conversations between a plurality of agents and customers of a remotely-situated client entity and identify keywords and speech characteristic parameters from the digital voice data. In specific embodiments, the data-communications server 110 captures the digital voice data via a client on the agent side, which may be communicating with a web client contact center and a client on the server side (e.g., a provider-side client as a circuit-based module inside the server 110) and provides the digital voice data to the processing circuitry 106. In other embodiments, the agent-side client communicates the digital voice data to the provider-side client. The provider-side client then provides the digital voice data to the analytics circuitry 102 for identification of keywords and/or speech characteristic parameters. The identification may include analyzing the digital voice data for matches to keywords and speech characteristic parameters stored in an archive and/or database 101.

As may be stored in the various information sets of the database 101, keywords and/or speech characteristic parameters may be associated with outcomes, in some embodiments. Example outcomes may include sale, no sale, positive or negative tone/sentiment. A tone or sentiment of the audio conversation may indicate how the call is perceived by the customer. A tone or sentiment may be identified based on the speech characteristic parameters. Example speech characteristic parameters include frequency, velocity, and amplitude of the conversation.

In a number of specific embodiments, the speech characteristic parameters may be compared to one or more thresholds. For example, the processing circuitry 106 via the analytics circuitry 102, using the provider-side database 101, may identify a speech characteristic parameter which is outside of a threshold value (e.g., indicating an issue or potential problem), and which may correspond to or be indicative of a tone or sentiment of the conversation. As a specific example, audio above a particular amplitude and velocity may be indicative of a customer or agent who is upset or otherwise agitated. The thresholds may include generic thresholds (anything above a particular value), thresholds that are specific to geographic regions or types of customers, and/or baseline values of the specific speaker or agent. For example, if the speaker or agent's speech is faster and louder than their baseline, the speech may be indicative of an issue in the conversation. Further, for certain of certain of the endpoint devices identified in the information sets and/or by way of the content of the incoming interactions being associated with certain conditional actions, the server 110 may predict or load the cache in anticipation of such speech and the call may be routed to a manager or other designated handler (e.g. other agent) better prepare to handle the call.

The processing circuitry 106 may provide an association of the keywords and/or speech characteristic parameters with outcomes based on the analysis. The associations may be stored in the database 101 and/or provided to a client data-communications server 121 as feedback via the feedback circuitry 104. The feedback may be provided to a manager of the client entity and used for training purposes. Additionally or alternatively, the feedback may be provided to the particular agent in real-time or near real-time, such as while the audio conversation is ongoing. The feedback may include specific phrases to use and/or suggested changes in speech characteristic parameters.

In other embodiments, the feedback is provided to a manager, such as via a report that summarizes a subset of agents for the client entity. The report may include customer interaction feedback using the associations indicating negative and positive outcomes and associated keywords and/or speech characteristic parameters.

In some embodiments, the processing circuitry 106 may identify a speech characteristic parameter outside of a threshold value (i.e., indicates a problem) or a keyword that is associated with a (manager) trigger and in response, automatically bridge a manager of the respective agent into the audio conversation. The processing circuitry 106 and/or the data-communications server 110 may access a database to identify the manager and information for bridging the manager into the audio conversation.

In some examples, the processing circuitry 106 may store the associations in a database as an archive that is accessible and that ties the keywords with dates of the conversations and the speech characteristic parameters of the particular transcribed audio conversations. The archive may be adjusted over time based on additional audio conversations. For example, the processing circuitry 106 may adjust the associations over time based on further analysis of digital voice data and provide the adjustments as feedback. Additionally or alternatively, the adjustments may be based on user input, such as input from an agent or a manager, as further described herein based on a tone/sentiment and/or keywords. In the description herein, various implementations and applications are disclosed to provide an understanding of the instant disclosure by way of non-limiting example embodiments exemplified by way of VoIP-type data communications which typically involve a data-communication server communicating with an endpoint device, such as a VoIP-enabled endpoint device (“VoIP device”) via a broadband network (e.g., Internet, WiFi, cellular) to connect with the data-communication server that is managed by a VoIP provider such as 8×8, Inc. and/or an Internet Service Provider (ISP) such as Yahoo or Google. Through such a server, call routing and other data communications services are managed for the endpoint device.

Users of a data-communications system may use a plurality of communication services to communicate with clients and other professionals and to carry out various tasks. For example, agents of a client entity may use a private network application to generate work products, a cloud-based application to manage service issues, another cloud-based application to manage direct communications such as email and chat messages, and yet another cloud-based application to manage financial matters such as billing and invoicing. In many instances, it may be beneficial for an entity subscribed to or that otherwise uses the data-communications system to analyze audio conversations across the entity (or across many entities) to improve subsequent interactions with the client or professional. For example, as a particular agent of an entity is conversing vocally with a client, the spoken conversation is captured and transcribed from audio to digital voice data (e.g., audio to data). In specific aspects, a data-communications server operated by the data-communications provider may capture and analyze conversations of many (e.g., 10,000 or more) agents, which may be stored in a directory. A client on the agent side may communicate with a web client contact center (e.g., via virtual access via the Internet), and a client on the provider side. In some embodiments, the client on the agent side may transcribe the conversation from audio to the digital voice data. In other embodiments, the client on the agent side may communicate the audio to a data-communications server operated by the entity, which transcribes the audio to digital voice data using processing circuitry in communication therewith. The processing circuitry may form part of the data-communications server or be separate therefrom. As used herein, the digital voice data is indicative of transcribed audio conversations between agents and others (e.g., customers or other external personnel) of remotely-situated client entities.

In specific embodiments, the processing circuitry analyzes the received digital voice data, the digital voice data being from the data communication services provided by the data-communications server. The analysis may include identifying keywords and speech characteristic parameters from the digital voice data, which may be, alone or together, indicative of a tone or a sentiment of a conversation (e.g., is the conversation going well or not). Example speech characteristic parameters may include a frequency, wavelength or velocity, and/or amplitude of the audio. In some embodiments, the speech characteristic parameters may be compared to a baseline of the agent to determine a tone. In other embodiments and/or in addition, speech characteristic parameters of the customer may be compared to thresholds to determine a tone. In a number of embodiments, the threshold may be different for different geographic regions, different types of customers (e.g., age, sex), different industries, among other types of classifications. In addition, particular keywords may be associated with and/or indicate a greater probability of a particular tone, sentiment, and/or outcome. As a particular example, the phrases “I want to speak to a manager” or “What is your name” may be associated with a conversation that is not going well for the agent. In other instances, “What is your name” at a particular frequency may be indicative of a positive outcome (e.g., an agent resolves an issue and the customer would like to commend the agent). Although as may be appreciated by one of ordinary skill in the art, embodiments are not so limited and may include a variety of different associations. Further, in various embodiments, the same keywords or phrases may indicate different tones or outcomes for different types of customers.

The identified keywords and speech characteristics may be associated with outcomes of the transcribed audio conversation. The associations may be provided in an archive stored on a memory circuit and which may be updated over time. In various embodiments, the outcome may be determined based on the keywords and/or metadata in the digital voice data. For example, the processing circuitry may identify the keywords and compare them to previously identified associations of keywords and outcomes. As a specific example, an entity may initially set up an archive to include associated words and phrases that indicate a sale has occurred, a subscription is continued, a customer hangs up prior to a sale, etc. Alternatively and/or additionally, the archive may include thresholds for speech characteristics parameters that are indicative of different tones or sentiments. The thresholds may indicate or otherwise be associated with a positive conversation, a negative conversation, and changes in threshold indicating a change from a positive to negative or negative to positive conversation. Such thresholds may adjust over time based on feedback into the system and corrections by agents. For example, prior to storing an outcome as associated with a keyword and/or speech characteristics parameter, the outcome and the association may be provided to the agent and/or to a manager for review and approval. In response to an input verifying the outcome, the association is stored. In response to an input correcting the outcome, the association is not stored or a revised outcome is associated with the speech characteristics parameter and stored.

The analysis of the digital voice data may be used for training purposes. For example, a particular agent is provided feedback after the call on what keywords to avoid and/or strategies for the next call. More specifically, the feedback may include providing the association(s) to the client data-communications server and/or to the endpoint device of the agent. In a number of specific embodiments, the feedback or training may be provided in real-time or near-real-time during the audio conversation. For example, the agent, via an endpoint device (e.g., a computer or otherwise) may be provided a display or audio that cannot be heard by the customer, that indicates keywords to avoid, keywords to use, and/or directs the user to change their speech pattern (e.g., slow your speech down, take a deep breath). In some specific embodiments, specific keywords, alone or in combination with specific speech characteristic parameters, may cause an auto-trigger for connecting a manager to the audio conversation. For example, another endpoint device that is used by the manager may be bridged to the data communication, such as a VoIP call. The data-communications server may access a database to identify the manager and information for connecting the manager into the audio conversation. In this way, a manager may be bridged into a call without additional action by the agent. In some instances, different customers may have different keywords or speech characteristic parameters that trigger the connection with the manager. These keywords or speech characteristic parameters may be based on previous audio conversations with the customer, identification of a category of customer (e.g., important customer that is ranked 10 on a scale of 1-10), among other analytics.

In various embodiments, the processing circuitry and/or the data-communications server operated by the data-communications provider or a client-side server may analyze the associations over a period of time and generate a report indicating different outcomes and associated keywords and/or speech characteristics parameters. Such reports may be used for training purposes and may also be used to identify different patterns. For example, customers from different geographic regions may interact similarly or differently from one another. As described, specific keywords or tones may indicate different outcomes based on geographic regions, markets, type of customer, etc. The data communications server and/or processing circuitry (which may be optionally integrated with this server) may provide an assessment of call quality based on the analysis, and provide feedback to the entity. The feedback may be used for training, which may be provided in real-time during the call or after.

In some specific embodiments, the analytics may be provided as a service by the data communication (e.g., VoIP) provider. For example, the analytics may identify keywords and/or tones/sentiments that result in positive outcomes, and also keywords that provide faster outcomes. Additionally, the metrics used to assess the outcome and/or the quality of the call may adjust over time. The adjustment may be responsive to additional digital voice data and/or verification or adjustment by the agents or a manager to ensure the determined outcomes are correct. In a more specific example, the feedback may be provided by identifying customer-interaction metrics in the digital voice data. In some embodiments, the associations may be locked and a manager reviews the recommended adjustments (by the agent) and approves or denies the adjustment. The customer-interaction metrics include values or ratings of an interaction of an agent with a customer. For example, the customer-interaction metrics may include different ratings, which may be impacted by the use or non-use of specific keywords, phrases, and speech characteristic parameters.

The processing circuitry may analyze the data over time and across a plurality of agents. For example, particular agents may be identified for an entity that has customer-interaction metrics outside a threshold value. Such agents, for example, may be provided feedback, as described herein, for training purposes. The feedback may include the identification of customer-interaction metrics to adjust for potentially better outcomes or specific outcomes (e.g., a sale or customer retention). In some instances, the feedback is provided in real-time and/or during the conversation, such as recommended phrases to say to the customer and/or recommended adjustments in the agent's tone. The customer-interaction metrics may be tracked over time and/or adjusted using digital voice data of additional audio conversation.

Another form of an example data-communications system is shown in FIG. 1B, which bears similar aspects as the system depicted in FIG. 1A. The example system of FIG. 1B also includes a data-communications server 138 configured as a unified communications and call center (UC-CC) platform, which is shown receiving different types which include the types of incoming interactions via one or more network channels at 140 similar to as discussed with FIG. 1A, and also incoming interactions associated with the server 138 engaging in conversational speech and with other data sources at via connections to other circuit-communicative endpoints through a broadband network (e.g., cloud-based). This pathway is shown connecting to external audio/video-communication-enabled equipment such as CPUs, smartphones, robots, etc.

An analytics (CPU) processor circuit 142 and other database/source circuitries 144 are shown being integrated with the server 138 but separated by pathways via one or more broadband connections. The analytics processor circuit 142 may be use as directly corresponding to the analytics circuitry 102 of FIG. 1A, or alternatively the server 138 may have the analytics circuitry internal (not shown in FIG. 1B) and the analytics processor circuit 142 may be used selectively by the server 138 to complement the data and associations of the information sets stored in the analytics circuitry internal to the server 138. The other database/source circuitries 144 permit the server 138 to be connected to other sources of information including, as examples, AI/ML resource services which may be trained via data fed by the server 138, customer systems, 3rd party servers (e.g., Lexis and Westlaw (online research), Salesforce™, Microsoft Dynamics, and other applications for business, research, etc.

The server 138, as shown with conceptual (not physical separation of) responsibilities at 148A and 148B, processes each of these different types of interactions via an integrated memory (e.g., the database circuit 101 of FIG. 1A) for access to information sets which may have user/client-entity contact information and/or experience data corresponding to past incoming data-communication interactions processed by the UC-CC platform. The server platform receives and initially processes an incoming interaction via channel 140 so that an initial step of analysis may be performed. This initial step of analysis, which again may be performed conceptually on one or both the UC and CC sides, may involve for example, security authorization, gate-way passing and/or handing off the incoming interaction to another module within the server or outside the server for further analysis such as the analytics processor circuit 142.

The vertical dashed line is used to show separation of responsibilities of the server conceptualized via UC side 148A and CC side 148B of the server platform; however, in certain example embodiments of the instant disclosure these UC-side and CC-side responsibilities may actually be implemented via physical/logical integration in various ways including the examples performed by the platform/processing circuit to provide an integrated secure-access environment and being performed as only one or a combination of one or more of the following. First, a high-level security-based firewall circuit for accessing one or more of the circuitries 101, 142 and/or 144 with secondary/tertiary level checks before granting access. Second, access to one or more of the circuitries 101, 142 and/or 144 being granted with the access pathway implemented as an internal bussing structure controlled by a database manager internal to the UC-CC platform, so as to control access requests to/from the platform. Third, granting such accesses while prohibiting traversal of any broadband gateway circuit and/or of any security-based firewall circuit. Fourth, granting such accesses so long as data provided from one or more of the circuitries 101, 142 and/or 144 so long as data provided from any one or more of the circuitry or circuitries 101, 142 and/or 144 occurs via a single access-based request-and-receive-data transaction, for example, a “single dip” transaction, involving only one of the circuitries 101, 142 and/or 144. Fifth, a limited number of such access-based request-and-receive-data transactions, for example, a “double dip” involving two transactions to any one of the circuitries and/or involving two transactions to two of the circuitries 101, 142 and/or 144 (or alternatively, a “triple dip” involving three transactions collectively to two or to three of the circuitries 101, 142 and/or 144). Sixth, granting such accesses while prohibiting (or exclusively permitting certain types of) data from being provided over any or one or more particular broadband networks, any or one or more particular gateways, and/or any or one or more particular security-based firewall circuits. Again, two or more these examples may be used in combination, for example, with the sixth example being used with fourth or fifth example.

Next, the incoming interaction may be processed by circuit-based modules which traditionally are more closely associated with only one of the UC and CC sides. For example, as depicted in FIG. 1B at the UC side, activities may involve functionality auto-attendant operations and/or a ring-group/call-queue operations to permit incoming callers to access experts/specialists (e.g., subject matter expert) having special knowledge concerning the nature, purpose or context of the incoming interaction as discerned by the analytics processing of the incoming interaction and/or as indicated by answers from the initiator (e.g., caller) of the incoming transaction to automated subject-based hierarchical queries from the server back to the initiator. The server/processing circuit may route such a particular incoming interaction to a discerned one of various possible selected experts (or specialists) having a high likelihood of being able to address the issue of the incoming transaction. In more specific example embodiments, the server/processing circuit may decide at which point to route the incoming transaction to such an expert or specialist (via real or virtual system extension x1001) based on a confidence level, relative to a fixed or variable threshold, that the discerned issue has been more than likely recognized as matching the knowledge category/categories of the expert or specialist. Moreover, the threshold and/or the manner in which the issue is discerned may be based on the server/processing circuit assessing data from, as examples: information set(s) accessed in the database (e.g., 101 of FIG. 1A); analytics circuitries/modules (which may or may not include AI/ML models) whether internal to the data-communications system and/or external via a broadband and gateway to/from the system (e.g., via analytics processor and/or other database/source circuitries 142, 144 of FIG. 1B).

At the CC side, activities may involve interactive voice recognition (IVR) operations to permit incoming callers to access information automatically via a voice response system of prerecorded messages without having to speak to an agent, and/or use menu-driven options to have their calls routed to specific departments or specialists, with or without similar confidence assessment as described herein in connection with the server/processing_circuit assessing data from the noted examples (e.g., via 101 of FIG. 1A and/or 142, 144 of FIG. 1B). As depicted at the bottom of FIG. 1B, the server/processing_circuit may route the incoming transaction to an agent, for example, via real or virtual system-based extension x1002, selected through the system's service-provided IVR experience.

Accordingly, with the example embodiment of the system shown in FIG. 1A, the related system depicted in FIG. 1B is able to facilitate an automated self-service experience for users by resolving inquiries discerned through the incoming interactions and/or effecting call-decision routing of incoming interactions to call-center agents or specialists, and this may be achieved by analyzing the incoming interactions and accessing possible associations relative to the information sets in the database, and/or other sources of information (and optionally, analysis).

In more specific examples and according to other aspects of the present disclosure, the UC-CC platform may process the incoming interactions in various ways and while making use of different resources (e.g., depending on the services linked to the respective incoming interactions and depending on aspects related to the call itself). The specific examples may be described herein, each of which is according to aspects of the present disclosure.

In connection with one such example aspect, the UC-CC platform is to read from the database to assess whether a selected one of the incoming interactions has source identification information associated with archived database information for indicating whether the selected one of the incoming interactions is to be routed, terminated or processed according to special instructions, and the UC-CC platform may write to the database to augment the database with information discerned from the inbound communication based on the source identification information and/or content deciphered from the inbound communication.

With regards to other example aspects, the UC-CC platform is to respond to a selected one of the incoming interactions: by iteratively accessing the database to assess for whether the selected one of the incoming interactions has archived associations stored therein and to augment the database with new associations generated in response to analyzing content from the selected one of the incoming interactions; and by, in sequence, assessing from the database whether the selected one of the incoming interactions has archived associations stored therein; assessing whether there is sufficient information in the database for the selected one of the incoming interactions to be routed, terminated or processed according to special instructions. Further, the UC-CC platform is to pursue may pursue at least one additional resource, according to client-specific profile data in the database, in attempt to gain more information for the selected one of the incoming interactions to be routed, terminated or processed specially based on said more information. The additional resource(s) may include a series of queries fed back to the initiator of the selected one of the incoming interactions, and wherein in response to the initiator answering one or more of the series of queries, the UC-CC platform augments the database with new associations generated in response the initiator answering one or more of the series of queries and/or trains AI/ML (artificial intelligence and/or machine learning) models to be use in processing subsequent incoming interactions.

In connection with yet further aspects, the UC-CC platform may respond to a selected one of the incoming interactions by performing an analysis on whether source information and/or content data warrants augmenting the database with newly generated associations, and also may perform the analysis based on one or more confidence thresholds, corresponding to metrics or parameters provided by client entities, which indicate likelihoods that the newly-generated associations have sufficiently-high integrity.

In a more specific example, the UC-CC platform includes a computer-based database manager for managing access (reads, writes, refreshes, cache management, etc.) to the database, which may be formed of different regions of memory circuitry and/or different memory circuits. In this context, the database manager may act as an interface to various modules (e.g., programmed circuits) in the data-communication system, which is to request access to the database for a selected one of the incoming interactions. As an example of the use of the database manager in an integrated secure-access environment, the UC-CC platform accesses the database through an access pathway in which the database manager resides to respond to access requests from the UC-CC platform. In more specific examples of this type, the access pathway is situated so that access to the database does not traverse any broadband gateway circuit and does not traverse any security-based firewall circuit, and alternatively for permitting access over the broadband network while limiting exposure to unauthorized accesses, the access pathway is situated so that access to the database does not traverse more than one broadband gateway circuit and does not traverse more than one security-based firewall circuit.

In another related yet more-specific example, the UC-CC platform of one or more of the data-communications systems accesses information regarding designated call-center agents and specialists which are stored in the database, and then routes the incoming interactions to the agents and/or specialists as may be appropriate given the particular details of the incoming interaction which are discerned by the UC-CC platform. In this regard, the UC-CC platform may also access the archived associations in the database for deciding whether to route respective ones of the incoming interactions to one or more of the designated call-center agents or one or more of the specialists having specific knowledge of subject matter discerned through the incoming interactions.

In certain situations, after a respective one of the incoming interactions is routed to a receiving party, whether one or more agents, one or more specialists or another party, the UC-CC platform may permit the initiating/receiving party of the incoming interaction to select a bridging option for causing a selected party to be bridged and joined into the incoming interaction and this bridging could be to anywhere inside or outside the system or client entity related to the incoming interaction. Further, in response to the selected party being bridged and joined into the current (e.g., live) incoming interaction, the UC-CC platform may archive information to associate the call and the bridging into the database for use in a subsequent one of the incoming interactions. Also, according to another aspect which may optionally be part of the automated self-service experience, the UC-CC platform may access the database for the subsequent one of the incoming interactions and in response to finding corresponding parameters for the incoming interaction, may cause the subsequent one of the incoming interactions to automatically bridge, or offer as an option to bridge, one or more agents and/or one or more specialists into the subsequent one of the incoming interactions.

As other aspects related to the above data-communications systems, the UC-CC platform may access the database for content in a selected one of the incoming interactions which content indicates whether to bridge a manager affiliated with an account, into the selected one of the incoming interactions. The affiliated manager may be identified by source information for the selected one of the incoming interactions and/or by associations stored in the database. Also, the UC-CC platform may bridge to such a manager into the selected one of the incoming interactions in response to discerning one or more of: keywords, context, intonation, and speech characteristics, and the UC-CC platform may discern, in response to the accessing of the database for a selected one of the incoming interactions, whether to offer an entity affiliated with the selected one of the incoming interactions, one or more data-communications services and/or data analytics packages through which the user or affiliated client entity might gain access to metrics, outcomes and certain AI/ML models which are part of or being generated by the system. The database may also include representations of digital voice data associated with transcribed audio conversations which correspond to one or more of the incoming interactions, and may further include geographic information and/or calendar information provided by or associated with the one or more of the incoming interactions, wherein the representations of digital voice data include keywords and speech characteristic parameters associated with outcomes of or with contexts relating to the transcribed audio conversations.

In another example aspect, the UC-CC platform may affect the call-decision routing of the incoming interactions to the described designated call-center agents or specialists based on a time-based assessment of whether the designated call-center agents or specialists are able to handle the routing of the incoming interactions. Such assessments of whether the designated call-center agents or specialists are able to handle the routing of the incoming interactions may be performed by predictive analysis, models and related system data.

Depending on the application, it will be appreciated that the UC-CC platform may be implemented to include a cloud-based set of data/call centers, at least one of which includes a plurality of data-communications servers respectively located in different physical locations, and that the UC-CC platform may include physically-separated virtual servers and/or circuit-based modules that are configured to work together so that they collectively function as a single unified server having integrated read and write access to the database without having to pass through a gateway of 3rd party entity (e.g., which is disparately managed relative to the service provider on behalf of the UC-CC platform). Also, such physically-separated virtual servers and/or circuit-based modules of the UC-CC platform may be configured and integrated for access to the database without having to pass through disparately-managed security-screening filters.

In accordance with the present disclosure, FIG. 1C provides a simple example of how an incoming interaction may be processed via a generalized data-flow diagram. The data-flow diagram shows one of many ways for how such an incoming interaction may be received and processed by one or more of the disclosed example data-communications systems (e.g., the UC-CC platform of FIG. 1A or FIG. 1B). FIG. 1C shows two processing pathways respectively illustrating what happens through two incoming interactions from the same initiator, in this example, the two incoming interactions being from Carl, a customer who calls in twice. Carl's first call starts at circuit-based block 162 and flows along a pathway including circuit-based blocks: front desk 164, billing 166, support queue 168, agent/specialist 170 and confirmation of (optionally with feedback to database 101 after) call-termination 174. Carl is transferred by the front desk 164 to Joe at billing 166. Billing 166 informs Carl that he really needs to talk to support personnel and hence, Joe at billing 166 transfers Carl into the support queue 170 where Sue answers. Sue is very helpful and resolves Carl's initial challenge involving his first call starting at block 162.

This processing of Carl's call (the first and/or second call) may or may not involve live communications with one or more humans who go by names Joe and Sue, and in the case of a human, Joe and/or Sue may be live agents or experts to which Carl's first and/or second calls may be transferred after discerning a likelihood that his/her assistance is appropriate.

Further, based on said one or a combination of two or more of the blocks 164, 166, 169 and 170, the platform (or processing circuit) generates further associations for storage in information sets as discussed in connection with FIG. 1A the data store or database with each such information set being linked, for example, to Carl via contact information for Carl), Carl's call-in device (e.g., CPU or smartphone), a client entity associated with Carl or his call-in device, and/or context discerned in connection with Carl's incoming interaction.

Continuing with this example, four months later, Carl has slept a few times and calls back in not remembering who he talked to but remembering things worked out well last time. This second call starts at circuit-based block 182 and flows along a pathway including circuit-based blocks front desk 186 (the same or different via a virtual front desk than front desk 164) and support queue 188 (the same or different via a virtual support queue than support queue 168), with block 190 corresponding to confirmation (optionally with feedback to database 101) of call-termination 174. Again, each of these blocks may or may not involve live communications with one or more humans. Accordingly, in this second call, the call from Carl is received by the front desk 186, which is prompted that “hey, the last time Carl called in, he talked to Sue, and our analysis of the call is that it went well”. This may occur with access to the (e.g., analyzed via analytics circuitry in FIG. 1A or 1B). So the front desk transfers the call promptly to Sue based on an access via the front desk 186 to relevant data in the data store 160 and possibly with Sue at block 188 again accessing relevant data in the data store 160.

Accordingly, for this second call, Carl's experience and resolution of Carl's challenge is based on one or more accesses to relevant data in the data store 160 (e.g., via the associations in information sets discussed in connection with FIG. 1A in the data store or database 101) by any one or a combination of two or more of the blocks 164, 166, 169 and 170.

FIG. 2 shows yet another example data-communications system with circuit-based modules highlighted to illustrate one way for how a UC-CC platform/server via cloud-based services 230 detailed to show one or more data-communications servers 232 (having provider-side client circuits 246 and processing circuitry 248), provider/client-specific databases 234 (e.g., as being within the database 101 of FIG. 1A), and data analytics packages 236 which may be subscribed to and/or accessed by selected client entities to which the platform provides data communications services.

In connection with the specifically-illustrated example of FIG. 2, endpoint devices 239, 241, 243, 245 connected in a data network 231 are configured to place and receive VoIP telephone calls between other VoIP endpoint devices, and/or between non-VoIP endpoint devices, although embodiments are not limited to VoIP communications systems. Non-VoIP endpoint devices may include, for example, plain old telephone service (POTS) telephones and cellular-capable devices, which might also be VoIP capable (e.g., smart phones with appropriate VoIP software applications). The various endpoint devices 239, 241, 243, 245 are associated with an account 238 of a client, e.g., Client A, and include circuitry that is specially configured to provide calling functions that include interfacing with the appropriate circuitry of the call service provider used by the corresponding endpoint device. In many contexts, a VoIP endpoint device is a VoIP-capable telephone commonly referred to as IP phones. The VoIP endpoint devices 239, 241, 243, 245 may include, but are not limited to, desktop computers, mobile (smart) phones, laptop computers, and tablets, such as illustrated by 240, 242, 244. When each of the endpoint devices originates or receives a call in a telephone network, each may be characterized or referred to as an addressable call endpoint or a dial peer. The client may have or be associated with one or more client databases 237 for storing various data and a client specific control engine 235.

The data (e.g., call) routing and other services for the VoIP telephone calls may be provided by one or more data-communications servers 232 within a UC-CC services system 230 which may be cloud-based as depicted in the example illustration of FIG. 2 (e.g., configured to provide a PaaS to customers of the VoIP provider). In particular example embodiments, the data-communications servers 232 may be located within platform as a service (PaaS) computing servers, which are part of the UC-CC services system 230. The UC-CC services system 230 also includes one or more provider hosted client-specific control engines 235. A client-specific control engine may also be implemented locally by a client (e.g., 246). In some embodiments, data centers may be part of a cloud-based system where the hardware providing the cloud services is located in a number of different data centers with different physical locations. Consistent with embodiments, the cloud services may include session initiation protocol (SIP) servers, media servers, and servers providing other services to both VoIP endpoint devices and the users of the VoIP endpoint devices. In some instances, the various servers, including both the data-communications servers and data analytic servers discussed herein, may have their functions spread across different physical and logical components. For instance, a cloud-based solution may implement virtual servers that may share common hardware and may be migrated between different underlying hardware. Moreover, separate servers or modules may be configured to work together so that they collectively function as a single unified UC-CC server.

A particular example of a data-communications server which uses Session Initiation Protocol (SIP) to handle various call functions (e.g., call setup and tear down); however, the various embodiments discussed herein are not necessarily limited thereto. Consistent with the examples and other embodiments disclosed herein, the data-communication servers are VoIP communications servers that are configured to establish a leg of the call from the VoIP endpoint devices (or dial peers) to another VoIP endpoint device, or to a gateway.

According to various embodiments, one or more data-communications servers 232 may monitor and analyze call data relating to digital call data of calls occurring using the VoIP endpoint devices 239, 241, 243, 245 via processing circuitry 248. For example, a data-communications server (in the UC-CC platform as with FIG. 1A) may be designed to receive digital voice data, such as directly from an agent-side client associated with particular endpoint devices. The agent-side client may communicate the audio or the digital voice data to the provider-side client. The provider-side client then provides the audio or digital voice data to processing circuitry 248 which may include analytics and decision-routing circuitries (e.g., as shown in FIG. 1A) and in certain more specific examples may include processing/communications circuitry internal and/or external to the data-communications system for further analysis, such as transcribing to digital voice data, identifying keywords and/or speech characteristic parameters, identifying an outcome, and providing an association between the keywords and/or speech characteristic parameter using the identified outcome. The association may be stored in an archive in provider-side and/or client-specific database(s) 234. In some specific embodiments, new keywords and/or parameter values are identified as having an association with an outcome. In other embodiments and/or in addition, a stronger correlation (e.g., probability) between the keywords and/or parameters is provided over time responsive to multiple verifications of an association. For example, a script running the data-communications server 232 may parse call digital call data and stored association to generate database queries that direct the data-communications server to provide a new association and/or update an existing association. The script may use the information to generate a report that may be used for training, promotions, and/or other analysis of agents. According to various embodiments, the database queries may be sent to a customer database 237. The feedback may be provided in real time or near real time to the endpoint device of the agent and/or may be accessed by a manager.

Additionally as another aspect of the present disclosure, in a system implementation a plurality of such UC-CC communications-service platforms (each according to one or more of the embodiments of the present disclosure) is deployed redundantly across a mixture of private and/or public data clouds and collectively said plurality of platforms enable such UC-CC platforms to switch in real-time or near real-time (effectively instantly for purposes of a system operation from a user's perspective and/or experience) to a redundant platform in the case of any service interruption. This enables services to be provided to end customers seamlessly and/or without interruption. Accordingly, in such a system, UC-CC platforms may act as redundant subsystems with each such platform being deployed across a plurality of data networks and/or clouds to provide redundancy, and with the plurality of data networks and/or clouds being private and/or public and being configured to enable each of the UC-CC platforms to switch to another one of the UC-CC platforms for redundant real-time or near real-time operation in the case of any event indicative of a possible service interruption.

As another of many advantageous points, such UC-CC communications-service platforms according to the present disclosure are readily configurable to self-provision of software updates and integration of various virtual resources, and if used, with automatic updates of associations in the provider-side database (e.g., 101) and automated training of the AI/ML models to handle future incoming interactions with more-intelligent and increasingly improving outcomes of challenges. This is in contrast to certain known on-premise contact-center types of systems in which although characterized as being fully unified, updating the software and ensuring the integration of all systems is functional cannot readily/practicably be done often and therefore may be very challenging and unduly expensive for IT staff to accommodate and more likely prone to error.

The skilled artisan would also recognize various terminology as used in the present disclosure by way of their plain meaning. As examples, the specification may describe and/or illustrates aspects useful for implementing the examples by way of various processes, circuits which may be illustrated as or using terms such as blocks, modules, device, system, unit, controller, and/or other circuit-type depictions. Thus, the terms should not be construed in a limiting manner.

Based upon the description and illustrations, those skilled in the art will readily recognize that various modifications and changes may be made to the various embodiments without strictly following the exemplary embodiments and applications illustrated and described herein. For example, methods as exemplified in the Figures may involve steps carried out in various orders, with one or more aspects of the embodiments herein retained, or may involve fewer or more steps. Such modifications do not depart from the true spirit and scope of various aspects of the disclosure.

In one or more embodiments disclosed herein, there may be one or more systems, methods, and/or apparatuses that facilitate, carry out, execute, perform, or the like video elevation/engagement within the context of a call center. In some cases, AI/ML and/or other software features may be utilized to further enhance video engagement. As described herein, engagement and elevation may be interchangeable unless otherwise specified.

For example, in one case techniques disclosed herein may be directed to functionality integrated into a communications platform (e.g., 8×8 Work as available at www.8×8.com or, alternatively, as a standalone app and/or data communications service). Such a communications platform may be configured to expand omni-channel engagement with an elevated-video experience that includes the ability for users (e.g., agents, supervisors, etc.) to control camera functionality of users (e.g., customers). The elevated video experience may be comprehensively enhanced and integrated into the communications platform, such as but not limited to one or more of the following: automated process flow to send launch an elevated video experience (including through customizable UX invites); GUI features (adapted for and integrative purposes in communications platform) to integrate this functionality into the communications platform (omni-channel orchestration) as well as including feature functionality within a meeting; contextual data fields included in elevated experience and integrated into communications platform to enrich and enhance user experience, processing efficiency, etc.; integration of endpoints (user-operated, Web-enabled communication devices such as smartphones, laptops, desk-based CPU stations, etc.) including third-party widgets within a single unified UX experience; ability to leverage ML/AI algorithms to generate contextually relevant data insights and surface them in the elevated video experience (also before/after); and improvements in analytics and reporting, among other benefits. Exemplary architectures of communications platforms, applicable for configuring the elevated-video experience of the present disclosure, are illustrated and described in connection with the figures (e.g., FIG. 1A, FIG. 1B, FIG. 1C and FIG. 2 as described herein).

In one non-limiting example, elevated video experience may be launched ad hoc through selection of GUI feature functionality (creating an adapted GUI/UX) that are integrated across any communication channel in 8×8 Work®. Such functionality may also be incorporated directly into a contact directory, where agents may automatically launch an elevated video experience from user contact information.

In other examples, an existing communication (e.g., electronic meeting) may be elevated to include this feature functionality, where users may switch a standard meeting to an elevated video experience (may be toggled on/off, and switch back and forth if necessary). The relevant communication may be via one or more channels (e.g., starting with one communication channel) and/or may also involve alternatively switching between communications channels. As an example of switching involving multiple communications channels: an agent may be communicating with a user through one digital channel (e.g., chat, messaging, email, phone call), and that may be switched over to another digital channel (e.g., meeting with elevated video experience functionality) that includes video with customized controls that enable the agent to control camera features (or video) of a customer during an ongoing communication. This may be very beneficial when agents are dealing with customers in any customer support scenario needing a viewing/inspection including retail, medical, insurance, construction/repairs, among other examples.

Aspects of the present disclosure may be used in any customer support engagement and with any type of user (not just limited to contact center agent/customer). In more specific examples, various aspects of the present disclosure may work in connection with any of various types of systems providing unified communications (e.g., ‘UCaaS’), contact center communications (e.g., “CCaaS”), communications platform as a service (e.g., “CPaaS”), for example, enabling usage of application programming interfaces (APIs) and the like to customize communication stacks and integrate chosen communication channels into applications, services, websites, etc., and/or a combination thereof (e.g., providing a platform which may be referred to as XCaaS (Experience Communications as a Service)). An exemplary XCaaS platform is designed from the ground up to support a vibrant ecosystem of deeply integrated applications providing a unified user experience (UX) enabling global communications through a plurality of communication channels, omnichannel interaction orchestration, extensible workspaces, customer interaction data, analytics and reporting, administrative console management of features and functionalities, third-party integrations of apps/services, widgets, etc., and machine learning and artificial intelligences, among other features and functionalities.

Certain aspects of the present disclosure may be used to provide comprehensive app/service integrable into XCaaS platform, providing a comprehensive, unified GUI to streamline management of customer interactions and support agents, for instance, Agent Workspace™ and/or Supervisor Workspace™ which provides contact center capabilities in 8×8 Work®. Elevated video experience window may be integrated inside an Agent Workspace/Supervisor Workspace UX to provide a single unified experience for agents.

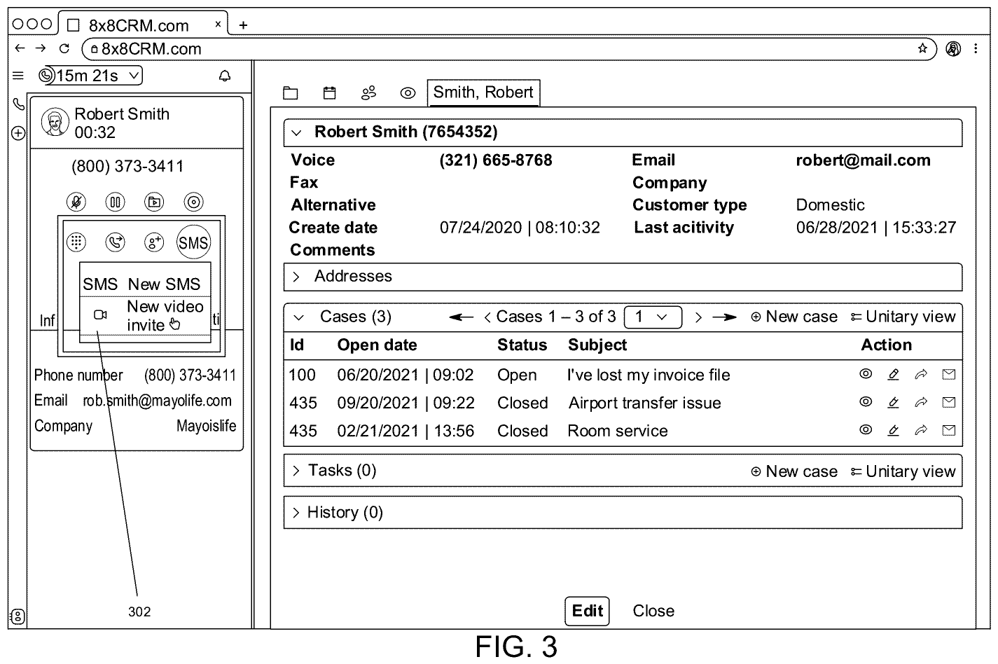

FIG. 3 illustrates an example screen of a GUI for a communications platform initiating a video elevation.

As discussed herein, a GUI may be accessible via an application that is purpose-built end client software for interacting with the platform, or may the GUI be accessible through a browser. In either case, the platform may be cloud based in the sense that the GUI functionality is largely provided by the platform (e.g., hosted remotely or locally, or combination thereof).

In one case, there may be a user experience (UX) of a communications platform adapted to include video elevation functionality, such as including selectable GUI features to trigger the launch of an elevated video experience via any channel of the communications platform creating omni-channel capabilities for users (e.g., agents) to communicate with other users (e.g., customers). For example, users may communicate from a user contact in-app to send an invite for customer to accept (note: Invite and disclosures during usage are important as a user wants to make sure proper consent is provided for recording, monitoring, camera control). For a communications platform (e.g., 8×8 Work®), omni-channel accessibility and integration of this feature may be configured, and may be a GUI feature accessible through chat, chat rooms, email, calls, meetings, linked docs (e.g., Google doc), IM/messaging, workspace UX (e.g., Agent Workspace, Supervisor Workspace), widgets, etc.

As shown in FIG. 3, there is an agent interface of the communication platform that is displaying a live interaction with a customer (labeled “Robert Smith”). The left panel shows the active call—evidenced by a timer (15 m 21 s) and the customer's phone details. Directly below the call controls, a menu is expanded where the agent may initiate different types of follow-up channels, including “New SMS” and “New Video Invite.” (e.g., see GUI button at 302). On the right side, there is information regarding the customer and their related information (e.g., number of cases, such as calls or interactions with the platform, etc.).

By selecting “New Video Invite,” the agent may “elevate” the interaction from a voice call to a video session. This illustrates an example of an initial step in the video engagement process—allowing agents to seamlessly transition to video to provide more personal or visual support. On the right side, there is a CRM or case management view for the same customer: it displays case history (e.g., open and closed tickets) and the customer's contact details. This type of information may be helpful in providing insights.

As shown, the communication platform may consolidate voice, SMS, and video options in one interface, enabling agents to quickly move from voice to video when it's beneficial for troubleshooting or customer service.

In some cases, there may be custom-created invitations that may be constructed to initiate video video elevation. For example, such aspects may include a contact field (e.g., phone number, email, personal contact details, and custom message). The invite may be further customized to include attachments and other contextual information (e.g., pulled from third parties or from platform data of the communications platform). For example, ML/AI integrations may pull summaries of past communications, contextual data points, etc., and populate that in the invite and/or elevated video meeting. This may help engage with the user and focus the communication.

In some instances, the communications platform may enable the invitation of one or more users, and possibly also include configuration for scheduling multiple iterations of meetings with one or more users depending on the scenario. For example, an agent may work at an insurance company, and be inspecting damage to one vehicle from a car crash, and then obtaining or receiving video from another vehicle involved in the crash.

In other examples, invite data field entry may be customizable including with selectable pre-populated features that agents may toggle on/off. For example, such aspects may include users to invite, additional contextual content for inclusion in an invite, consents, sending of notifications (e.g., modalities such as SMS, email, chat, etc.), audit reporting/receipts (e.g., to supervisory agents), analytics to track on communication, etc.

In an example with consent control as one specific type of data field that may be toggled on/off, an agent may wish to send quality control consent (e.g., monitor, store, record, data), as well as consent to control camera functionality through elevated video experience, among other examples. An agent may select checkboxes to add to those pre-populated messages. Alternatively, an agent may wish to include one consent (quality control) and then address another (e.g., control of camera functionality) once the customer actually engages in the video meeting, and may selectively choose one and not the other.

In alternative examples, an invite does not need to be populated and may be automatically sent through adapted GUI feature functionality to automatically launch an elevated meeting and present a customer with the ability to join in when ready. In the case where consents are not populated in the invite, the system may automatically provide those through in-app UX messages within the elevated UX experience (or to a user's other mobile device).

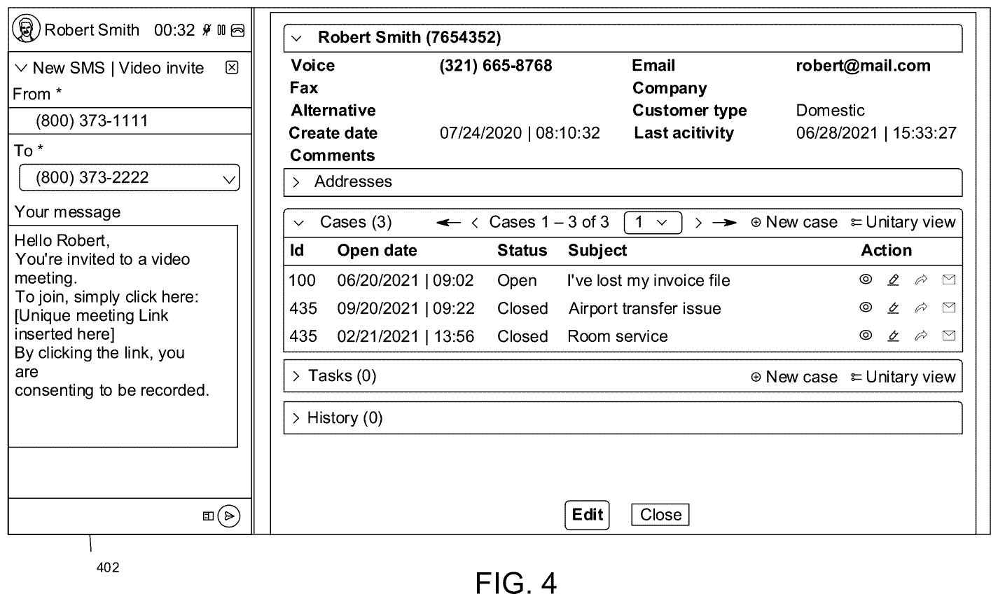

FIG. 4 illustrates an example screen of a GUI for a communications platform with an initiation message. As shown, the communication platform may present an interface to an agent that enables the agent to initiate a video engagement with a customer during a phone call. On the left side (e.g., at 402), there is an expanded panel labeled “New SMS|Video invite.” The agent may select a “From” number (the company's phone line) and a “To” number (the customer's mobile), along with a prepopulated message inviting the customer to join a video meeting.

Below, the message includes an automated meeting link for the customer to click and join (e.g., where the clicking would allow a customer device to open an application specifically for connecting a video call; in some instances, the video call would be enhanced with additional functionality and features as described herein). This illustrates the video elevation workflow—moving from a voice call to a video session by sending a secure SMS invite, as one example. Meanwhile, the main window on the right may display the customer's record, showing open and closed cases. The integrated view allows the agent to handle the phone call, access case history, and create a video invite all within one interface.

Once an invite is sent, the system may automatically launch interactions (e.g., with full control over communication via the communication platform) as well as launch video and control functionality. This may be done all in one UX workspace, and/or one or more windows.

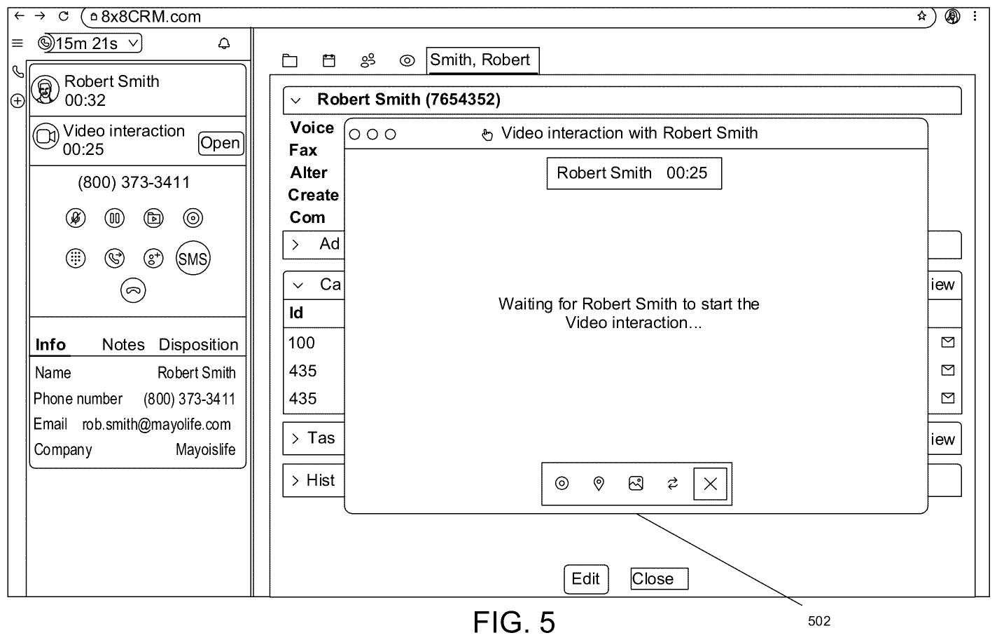

FIG. 5 illustrates an example screen of a GUI for a communications platform with video engagement beginning. As shown, the GUI presented to the provides an example where an agent has already initiated a video call with the customer (Robert Smith). The pop-up window labeled “Video Interaction with Robert Smith” (e.g., at 502) shows that the video session is in progress, but the system is still “Waiting for Robert Smith to start the video interaction.” On the left side, the agent's interface indicates an ongoing voice interaction (with a call timer) and now also a “Video interaction” in a separate tile. This demonstrates how an agent may upgrade a traditional voice call to a video-enabled conversation within the communications platform, allowing the two parties to speak face-to-face, and/or other video use cases as described herein, once the customer accepts and joins the video.

The customer receives the video interaction invite via communication modality chosen in the invite process, and is provided with link to join the interaction. The system may also send requests for permissions, additional consent requests, etc.

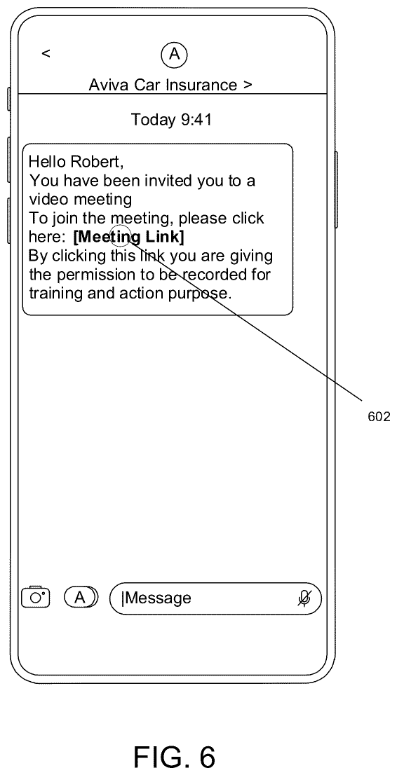

FIG. 6 illustrates an example screen of a customer device with an invitation for video engagement. As shown, there is a customer's view on their mobile phone after receiving a video invitation via SMS from a contact center agent. The text message includes a unique meeting link that (e.g., at 602), when clicked, launches the video session (e.g., an app on the phone that facilitates the video engagement). The SMS may also include a brief disclosure about call recording. This illustrates the customer's perspective of video elevation beyond the agent's interface to the customer's device—enabling a quick, seamless transition from a voice-only conversation to a video meeting by simply tapping the provided link.

In some examples, the customer may provide permissions for another user to access camera functionality, for example, granting permission to an agent to control camera through the elevated video communication experience. Once that is done, it is automatically transferred into an elevated video experience (e.g., where an agent may control user's camera, or other aspects about the experience).

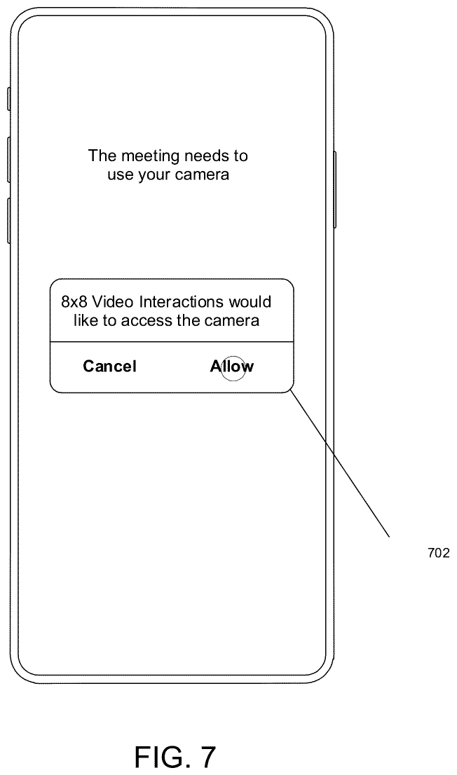

FIG. 7 illustrates an example screen of a customer device concerning permissions for video engagement. As shown, the customer's smartphone is prompting them to grant camera access before joining the 8×8® video interaction. After clicking the invitation link sent by the agent, the customer sees a standard permission prompt—“8×8 Video Interactions would like to access the camera.” This step is part of the video elevation process: the customer must allow camera access in order to participate in a live, face-to-face interaction with the contact center agent (e.g., see at 702).

In other examples, the platform permits for control being shifted to the agent. In such examples, toggle controls may be used for an agent to move camera (e.g., left, right, up down, rotationally (<=360 degrees), control the device in other ways, take video clips, tag/place markers on items within the field of view of the camera feed (e.g., in an augmented reality sense), geo-locational markers, flip view back to user, end control session, shift control back to the user, record, turn on meeting summarization, add notes, request insights, turn off insights, etc. (e.g., and/or other features disclosed herein). In further examples, GUI control elements are presented and configured to enable control of a camera of a user device to be toggled between devices (e.g., end user devices, agent devices including different agent devices participating in a video call).

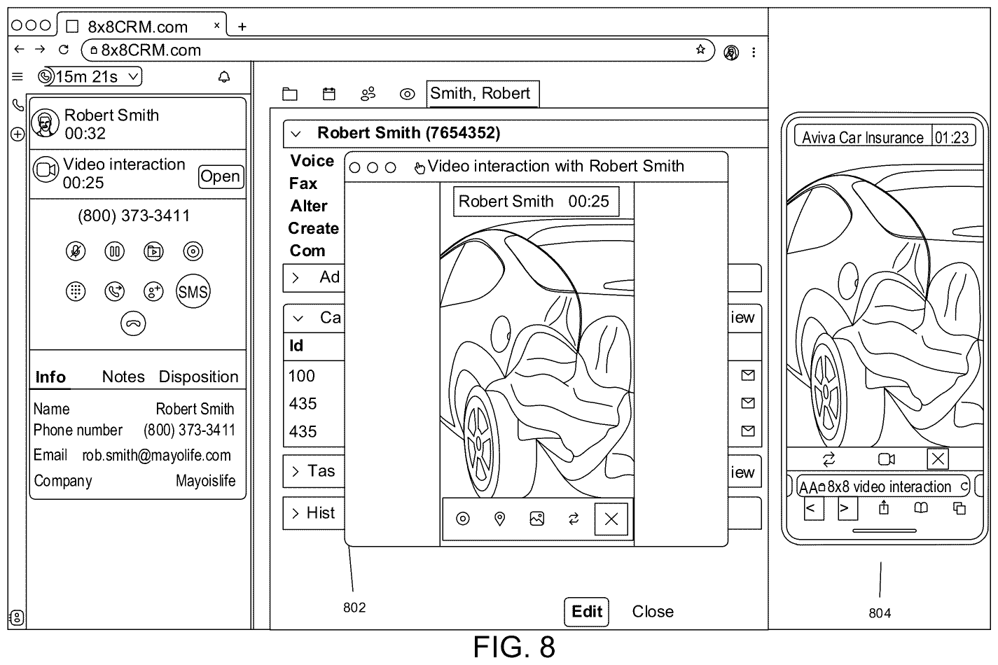

FIG. 8 illustrates an example screen of a GUI for a communications platform with active video engagement and an example screen of a customer device with active video engagement. As shown, there is an active video session between the agent (e.g., 802) and the customer (e.g., 804), illustrating a typical video elevation use case where visual confirmation or inspection is needed. On the left (the agent's interface), there is the “Video interaction with Robert Smith” window displaying a live image of the customer's damaged vehicle. On the right, the customer's phone screen is visible, showing how they are broadcasting their camera feed to the agent.

This setup demonstrates how the communications platform allows agents to elevate a standard call to a video interaction so that both parties may share real-time video—in this example, for insurance purposes or damage assessment. The agent sees a damaged car, thereby providing faster and more accurate assistance.

In certain examples, aspects of the present disclosure permit for utilization of ML/AI integrations, third-party widgets, etc. to enhance video experience, including providing agent contextual data insights to streamline customer communication, geo-locators, capture the relevant video/photos, and generally improve customer satisfaction.

For example, such aspects may analyze data endpoints from the communication platform (e.g., big data sets) including past communications, historical context across omni-channel experience, context of video/camera stream, voice/sentiment, etc., to provide real-time (or near real-time) data insights. GUI is customized and adapted to be able to surface these insights for the agent to control and adjust all within a single UX experience.

Such aspects may further permit for association with a customer device (e.g., associating with a user's mobile device through installed app) to collect relevant contextual signal information from the device (e.g., geo-locational tags, device ID, user ID) and enhance experience (e.g., extensible-expand and elevate video experience).

In one instance, an agent may assist a user with investigating a car accident. ML/AI tools may perform contextual analysis and provide suggested actions (e.g., take photos, adjust camera, make video stream, ask customer questions about what is in view, ask the customer to confirm what is in view after providing a real-time assessment of what is in view, etc.). Also, the tools may summarize past communications across communications platform, and provide talking points, topics of interest, provide the agent with information that the customer has already provided to avoid re-asking questions, among other things, such as quick links to other communications channels (e.g., across communications platform), create next steps/follow-up actions, etc.

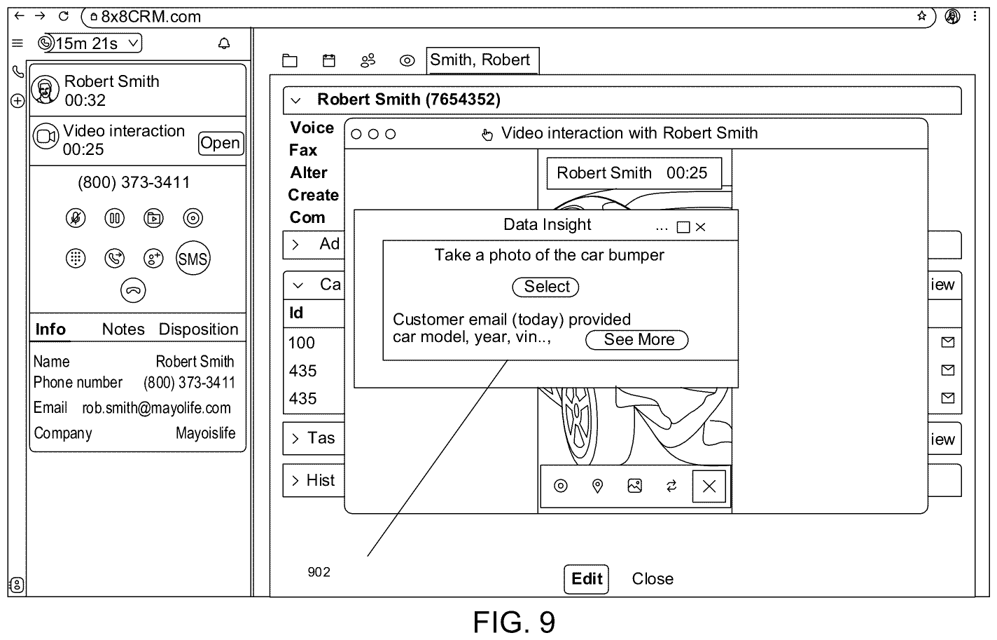

FIG. 9 illustrates an example screen of a GUI for a communications platform with active video engagement and on-screen insights. As shown, communication platform is displaying the agent's interface running an active video session with a customer (Robert Smith), who is showing damage to their car in real time. On the left, the agent's panel indicates both a voice and video interaction in progress. In the center, the video window displays the damaged vehicle.

Overlaid on the video is a data Insight pop-up (e.g., 902) with tasks like “Take a photo of the car bumper” and indicating additional context (e.g., the customer's email from earlier today provided the car's model, year, and VIN). These insights are provided by an AI/ML component of the communications platform that may be configured to appear during a video engagement, helping the agent quickly gather all relevant information or instruct the customer on the next steps. These real-time data insights may provide faster and more accurate service and may ultimately shorten the length of the engagement given its increased efficiency.

In some cases, the communications platform may provide additional contextual data into an elevated video experience, for example, user Links to third-party integration (e.g., CRM such as SalesForce) to elevate the experience.

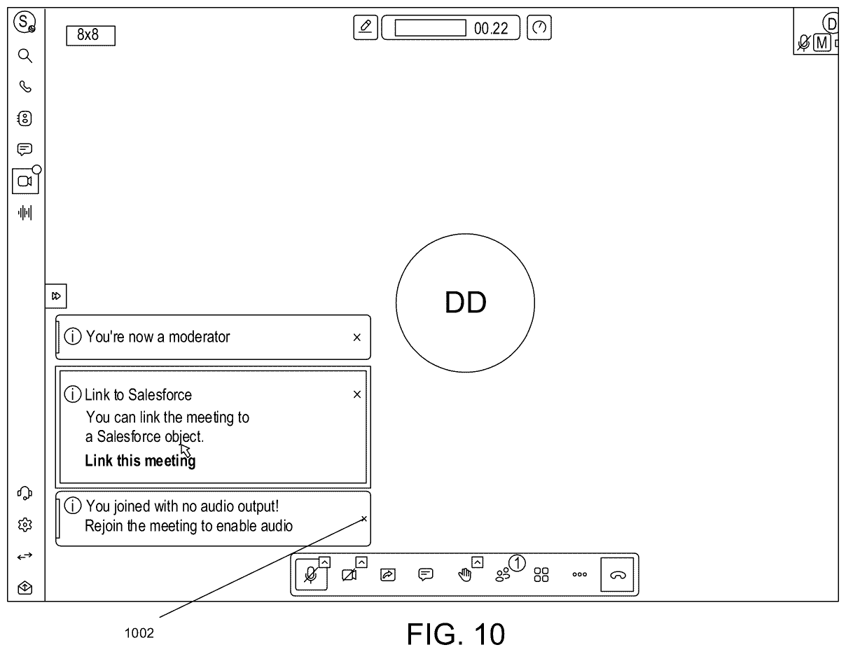

FIG. 10 illustrates an example screen of a GUI for a communications platform with engagement and on-screen insights. As shown, the communications platform interface is in the middle of a live meeting session (e.g., agent and customer). The user (e.g., agent) may be presented with real-time, or periodic, notifications on the left side (e.g., 1002), including a prompt to “Link to Salesforce” so the meeting summary (or other recorded data) may be automatically associated with a corresponding record in an external CRM system. These notifications highlight how AI-driven insights or platform intelligence within the communications platform may recommend next steps—such as linking to Salesforce, rejoining the meeting with audio, or providing other context-based actions.

In one case, large data sets and communication analytics may drive these intelligent insights/prompts, surfacing contextually relevant links and actions to streamline agent workflows. By connecting to external systems (e.g., Salesforce) or pulling from extensive interaction history, the platform may help agents quickly access and update the most pertinent customer or case information—all within the same communications platform.

This feature may automatically enable a user to bring contextual information into meetings (expand ability to generate real-time data insights through ML/AI). Trained ML/AI processing (e.g., one or more trained machine learning models) may be adapted to evaluate data sources integrated into an exemplary communications platform (e.g., communications platform such as 8×8 Work®), omni-channel orchestration of data points that include native data sources as well integrated third-party endpoints (e.g., third-party integrations including CRM tools). Contextual data may be derived from any data point individually or in aggregation, including historical signal data or current signal data (e.g., an ongoing communication such as an electronic meeting). For example, historical signal data collected from prior user communications may be combined with current user-specific signal data, device-specific signal data, etc., during an electronic meeting to generate and surface contextually relevant data insights for a user (e.g., agent assisting a customer). This unique and comprehensive analysis of big data managed through a communication platform enables the provision of rich and contextually relevant data insights tailored for a specific purpose (e.g., enhance user communication such as agents/customers in an elevated video communication). Exemplary signal data analysis may further be utilized to yield determinations as to how (and/or when) to generate updated analytics (in real-time or near real-time) and/or reporting, as well as when and how often to present data insights and/or suggestions. For example, it is important to properly evaluate a state of communication and identify contextually relevant data within an ongoing electronic meeting (e.g., dependent on user's sentiment, topic of conversation, content being presented, user attendance, etc.) relative to historical data and/or predicted patterns of users, which may help to determine not only the correct data to surface but when that data would be most beneficial to the participants.

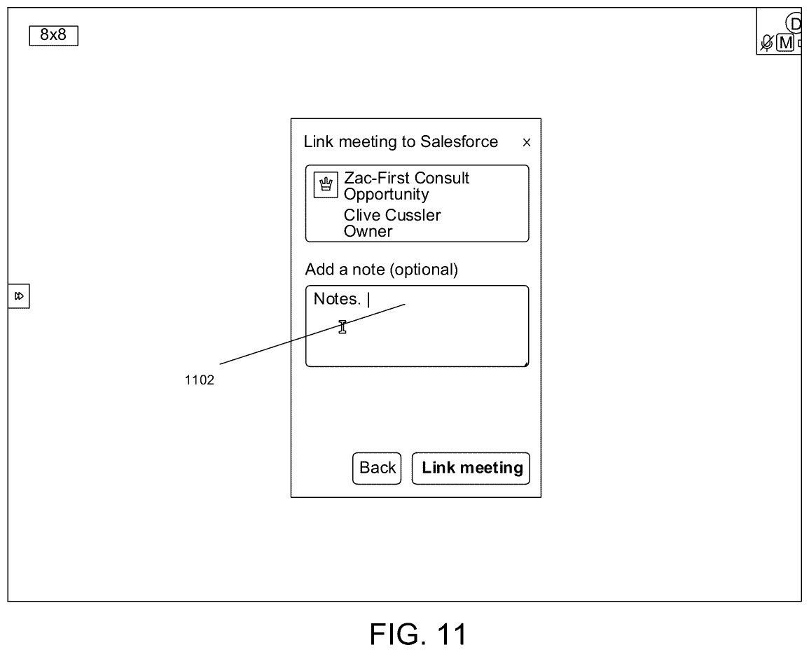

FIG. 11 illustrates an example screen of a GUI for a communications platform concerning external linking. As shown, the user is prompted to “Link meeting to Salesforce,” where they may select the relevant Salesforce record (e.g., a contact card with “Zac—First Consult,” owned by “Clive Cussler”) and is provided with an option to add notes. This illustrates how the communications platform may integrate with external CRM systems and automatically surface the correct object or record based on the context of the interaction. See, for example, the option to add notes at 1102.

By enabling the agent to link meeting details or notes directly, the platform streamlines post-call follow-up, ensures important customer information is captured in Salesforce, and reduces manual data entry. The intelligence behind this linking process may come from AI-driven insights or the platform's ability to mine large datasets and previous interactions, enabling a more automated, context-aware workflow for agents.

The communications platform may use a directory to send elevated video invite to users directly from a meeting through adapted GUI with full automated menu and controls.

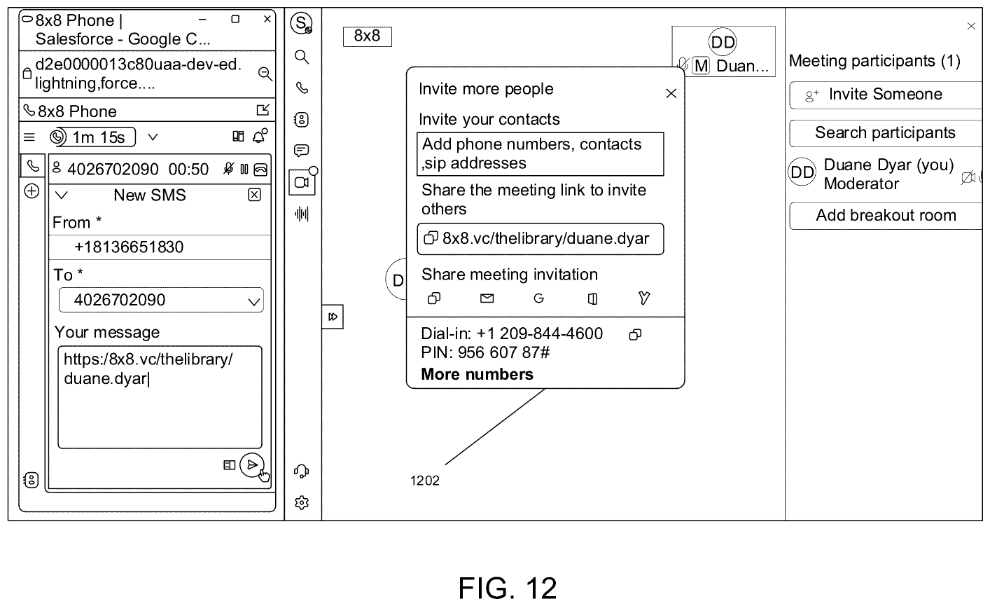

FIG. 12 illustrates an example screen of a GUI for a communications platform ending video engagement. As shown, the communications platform displays two key panels side-by-side. On the left panel (e.g., New SMS Interface) has a box for an agent composing a text message to invite a participant to a video meeting, where there is a “From” and “To” phone number field and a message body containing a video meeting link, and by sending this link, the agent may instantly elevate a voice or chat interaction into a live video session. On the right panel (e.g., Invite More People Window) there is an ongoing 8×8® video meeting, where the agent may invite more contacts by sharing a direct link, dial-in number, or other invitation methods (e.g., see pop-up at 1202, with ability to share meeting invitation with others).

Together, these panels illustrate how the communications platform video engagement feature allows agents to quickly transition to video and easily bring additional participants into the conversation. This seamless process enhances collaboration, whether for troubleshooting, customer service, or sales demos.

As an example, after a meeting has ended, the communications platform may populate key contextual information from elevated video communication, and link that information into CRM.

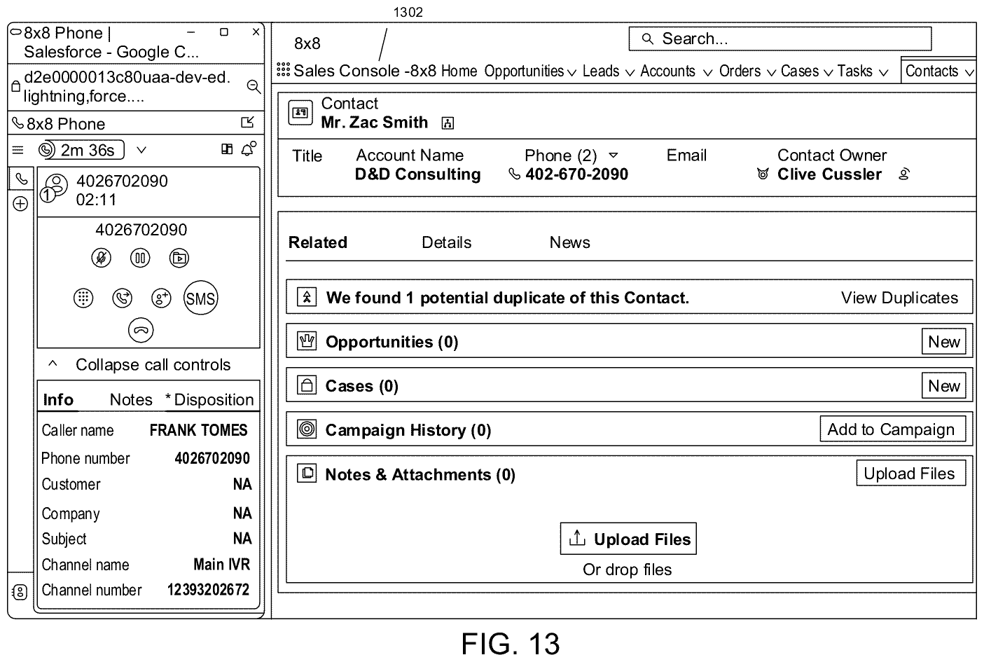

FIG. 13 illustrates an example screen of a GUI for a communications platform integrating with CRM at the end of a meeting. As shown, there is a phone panel on the left, embedded within the CRM interface (on the right). From the left panel, the agent may manage calls, view caller details, take notes, and potentially initiate a video engagement (e.g., elevating a standard call to a video session) if needed. Meanwhile, the CRM record for the contact (“Mr. Zac Smith”) is open on the right side, showing related Opportunities, Cases, and other information. See, for example, the sales console at 1302.

This setup demonstrates how the call functionality may work in conjunction with a CRM like Salesforce, providing contextual data where the agent sees call details (caller name, phone number, IVR channel) in the left panel, while also viewing matching Salesforce contact records on the right, so they may quickly reference account history and other information. Further, there are also omnichannel capabilities, where within a single interface, the agent may handle voice calls, add notes, and—if the interaction requires it—send a video invite to visually engage with the customer. This example shows video elevation and omnichannel features are embedded in the communications platform allowing agents to switch between communication channels (voice, SMS, video) without leaving a single environment (e.g., desktop, mobile, web, etc.).

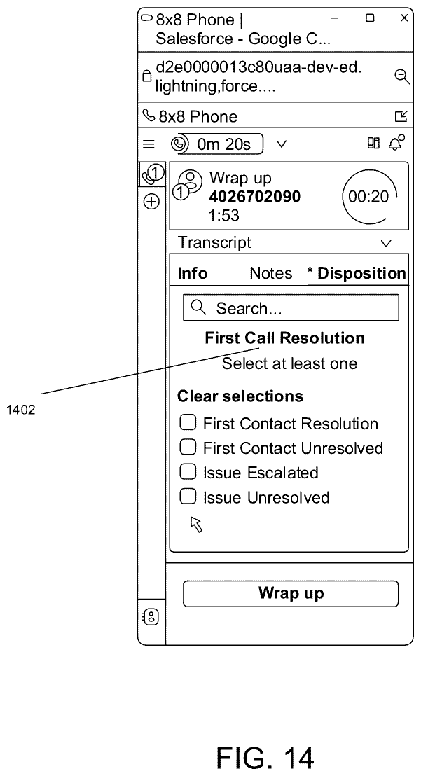

FIG. 14 illustrates an example screen portion of a GUI for a communications platform integrating with CRM. As shown in this screenshot, the 8×8 Phone panel (integrated with CRM, such as Salesforce) is showing the wrap-up stage of an interaction. In this example, the agent has concluded a call—potentially one that was elevated to a video session at some point—and is now required to assign a disposition (e.g., 1402) (e.g., “First Contact Resolution,” “Issue Escalated”) before finalizing the interaction. This input into the communications platform may be stored in more than one location, and thereafter used by the AI/ML to generate additional insights. For the scenario of this example, even after a video engagement, the agent completes the same post-call workflow—logging relevant information, adding notes, and choosing the outcome—within the interface. This enables the communications platform to provide and store consistent record-keeping, as well as generate comprehensive reporting across all communication channels, including those that involved video.

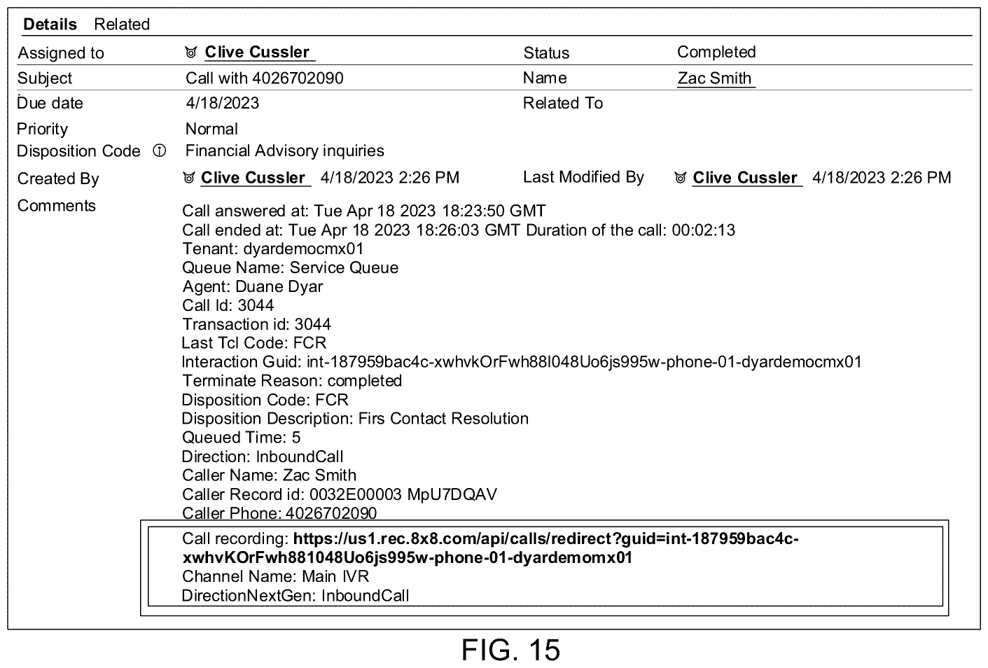

FIG. 15 illustrates an example screen of a GUI for a communications platform with engagement report. As shown, there may be an engagement record after an engagement has been completed. The engagement may have been conducted on one or more channels. A number of details may be captured, such as but not limited to, call answer time, call end time, tenant parentheses for phone line switching parentheses agent, call ID, transaction ID, last TCL code, interaction ID, termination reason, disposition code, disposition description, queue time, direction, caller name, caller record, caller phone, etc. The data in the record may be provided as input by the agent, generated automatically by the communications platform in conjunction with AI/ML assistance, and/or be a combination of manual data input and automated data input. In one instance, the communications platform automatically captures and logs key interaction details, such as the caller's number, queue name, agent, and disposition code—along with a recording link for the completed call. This same mechanism may apply to video interactions: if an agent and customer engaged in a video call, details about that session (including a link to the recording) would similarly be attached to the record. By integrating these records within the CRM, the communications platform may dynamically provide relevant information, automatically, or through an interface that the agent may quickly interact with to reference past interactions (e.g., voice or video, or the like) and all associated metadata (e.g., date, time, duration, disposition, etc.). This ensures a consistent, unified history of customer communications, whether the interaction took place via standard voice call, video engagement, or any other channel. Further, this record provides data that may be analyzed by AI/ML to provide insights. In one instance, there may be may a link to an elevated recording in CRM (also through communication platform such as 8×8 Work).

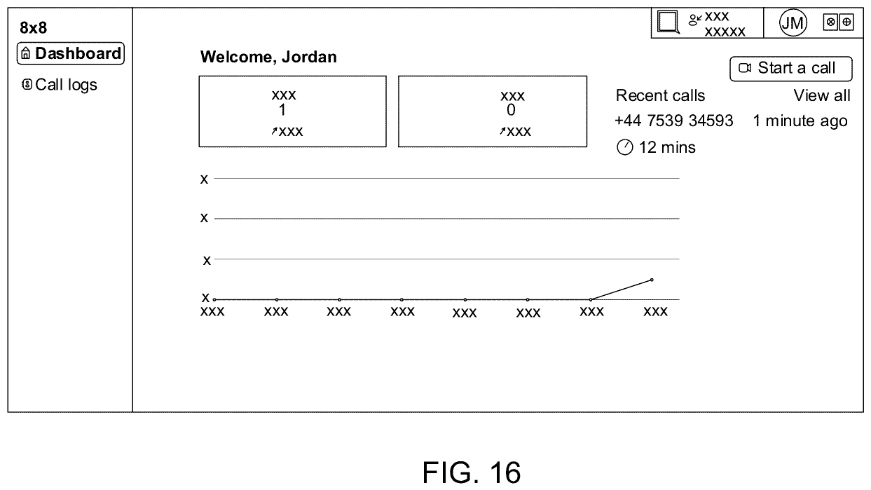

FIG. 16 illustrates an example screen of a GUI for a communications platform with an analytics report. Call records may be analyzed to generate reports, as shown (e.g., on a dashboard of the communications platform). Note, the specific metric being tracked would may present in chart form (e.g., as shown labels may replace the horizontal and vertical axis markers on the chart instead of xxx). Such statistics may be tracked over time with respect to a specific call, customer, or many interactions of one agent or one customer, or the like (e.g., as described herein). This information may further be used as signal data for AI/ML analysis and insight generation.

In some cases, during an elevated video engagement, the communications platform may present an interface to receive input from the agent regarding the interaction, such as where an agent may have by able to operate certain controls over the engagement, document information, annotate on a live screen, etc. When an agent makes changes, it may be displayed on the customer's end as well, or may only be known to the agent.

Additionally, the communications platform may filter the presentation or availability of the controls that are displayed for a given user. For example, the customer may be presented fewer controls compared to what is presented to the agent since the agent may be more familiar with the system, and is usually in the position of support with the goal of directing the issue resolution for a given use case (e.g., an insurance agent noting damage to property).

Further, during the video engagement, other features of the communications platform may be available through a menu or dynamically presented (e.g., utilizing UCaaS, CCaaS, CPaaS, etc.), such as to send follow-up messages, reminders, schedule follow-up meetings, etc.

In some cases, annotations and customer device control may be a feature utilized during video engagement.

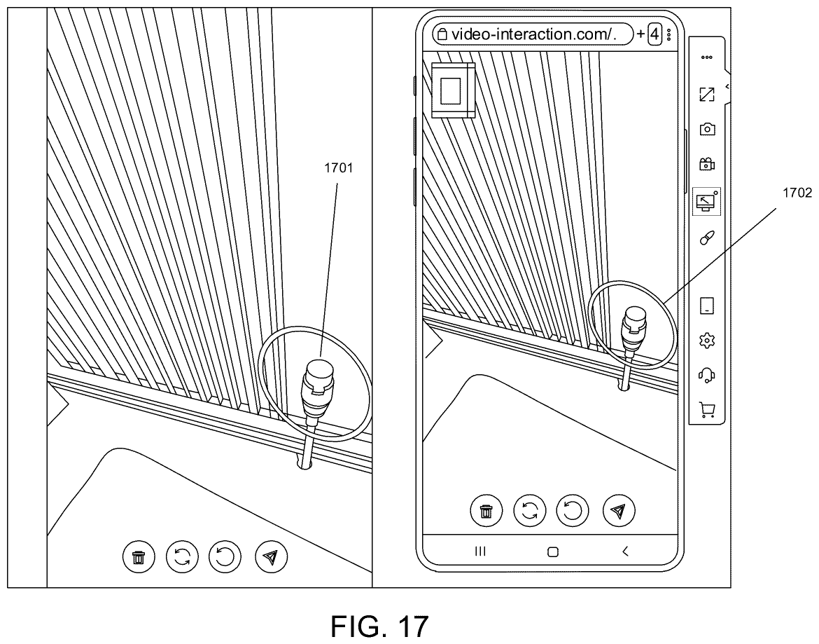

FIG. 17 illustrates an example screen of a GUI for a communications platform with annotations. In one example, a user may have the ability to annotate what is seen through the video call. As shown, there are two screens (e.g., one of each user, agent and customer) and the annotation made on one screen may be replicated on the screen of the other user. As shown, on the left side there is a customer's perspective that shows a circle 1701 during a video call, and the interface of the agent's perspective also shows the circle. In this example, either user could have created the circle (e.g., one use case, as shown, may have an agent drawing a circle around a valve so that the customer knows what object the agent is referring to in order to troubleshoot a malfunctioning residential heating element).

Additional controls may be presented on the communications platform that enables control of a customer device. For example, if the customer device is a smart phone, the communications platform may have direct control over the device (e.g., via the application running on the device, a web app, third party application, etc.). The communications platform, based on receiving input from an agent, or by automated determination by the platform itself, may configure the customer device depending on the use case. For example, if the device has more than one camera, the communications platform may control which camera is being used. For example, the device may be controlled to use a speaker or ear piece to output audio. For example, the device may have a light that may be turned off and on. For example, data from sensors may be requested and collected in real-time.

In one instance, annotations on a video call may be relative to the screen of a user. For example, if a circle is drawn in the lower right side of the screen, then when the camera feed of the video call changes orientation or moves, the circle is still in the bottom right side of the screen. This may be particularly helpful if the annotation is text presented in a box in the corner of a window so that, for example, an agent could provide the customer with written instructions if support is needed where a very loud machine is operating. In some instances, the annotation may be AI/ML insights or suggestions that may be generated by the platform's AI/ML component, and provided to the GUI of either or both GUIs. In some instances, an AI/ML insight(s) may be presented as an option to the agent that can then be selected as an option

In one instance, the annotation is fixed relative to what is being shown. During a video call, an augmented reality (AR) may be used, where an annotation stays with an object that is visible in the live camera feed of the video call. For example, AR on a phone may use the device's camera feed, motion sensors (e.g., the gyroscope and accelerometer), and/or computer vision algorithms to understand where the phone is in 3D space and how it's moving. When an annotation is made—such as drawing a circle or placing a digital note on an object in the live camera view—AR functionality may identify feature points in the video (e.g., edges, corners, or patterns) that serve as anchors, thereby enabling an annotation that is “pinned” to those anchors in virtual 3D coordinates. This functionality inherently requires operations on both the customer device and the communications platform. As a phone is moved around, the AR may continuously track the phone's position and orientation relative to these anchor points, so the annotation appears to stay fixed in place on the real-world object. Essentially, the AR is always recalculating the annotation's position in the live video, keeping it aligned as if it's really stuck to the physical item. AR calculations may be performed on the communications platform, the customer device, and or on both.

In some cases, the communications platform may perform one or more functions, such as but not limited to: Recording of meetings; Summarization (e.g., call transcript, video recording analysis, etc.); ML/Integrations; Add in additional video streams (e.g., agent leg, video legs of other users); Scheduler to include multiple users, schedule follow-up elevated video; Inclusion of third-party integrations into elevated video (e.g., widgets, expanded features functionalities); Quality Management/Speech Analytics/Sentiment Analysis; Feature Flags (toggling on/off); Customization of invites; and/or, Ability to aggregate interactions (e.g., stitch together timeline) to create comprehensive elevated video experience (asynchronously).

Aspects of the present disclosure may be implemented to provide exemplary technical advantages. Such exemplary technical advantages may be provided by processing described in the present disclosure and may comprise but are not limited to: feature functionality providing in-app elevated video experience to transform electronic communications such as electronic meetings including integration into a software platform (e.g., communications platform such as 8×8 Work®) or as a standalone app/service; GUI feature functionality specifically configured for management of video elevation experience thereby creating an adapted GUI from what is already known; ability to automate processing to schedule and launch elevated video communications including through meetings; automation of processing to obtain consents and use permissions in compliance with laws and regulations; generation and application of ML/AI algorithms that are configured to generate contextually relevant data insights for an elevated video experience and further integrated across all channels of a communications platform (e.g., omni-channel engagement); implementation of one or more trained machine learning models (e.g., a hybrid machine learning model) to execute and to improve efficiency and accuracy in generation of data insights and surfacing of notifications (including when and how); improved processing efficiency (e.g., reduction in processing cycles, saving resources/bandwidth) for computing devices when conducting electronic communications such as meetings as well as managing omni-channel communication interactions across a software platform (e.g. communications platform); reduction in latency through efficient processing operations that automate processing to launch elevated video experience including adapted GUI/UX feature functionality for user control during an electronic communication; improve correlation of a larger volume of data of a software platform including an ability to create and surface contextually relevant data insights, ability to generate timelines of communications including elevated video experiences; improving data points to enrich contextual data around engagements or opportunities including follow-ups, next steps; improving usability of host applications/services for users via integration of processing described herein; permit a first type of user (e.g., an agent/client-entity user of communications service) to overcome technical issues concerning provision of multimedia (e.g., video) by a second type of user (e.g., customer) by using controls that enable the first type of user (e.g., agent) to control camera features (or video) of the second type of user (e.g., customer) during an ongoing communication between the two, and extensible and scalable solution that may be adapted for any type of system or even include multiple iterations for targeted use cases within an environment including integrations of apps/services whether native or third party, among other technical advantages.

Using exemplary types and/or architectures of communications platforms (e.g., as disclosed with FIG. 1A, FIG. 1B, FIG. 1C and FIG. 2) for providing data communications services to an agent (e.g., a first type of user) registered to receive such services, such elevated-video experience according to the present disclosure may utilize AI/ML (artificial intelligence and/or artificial intelligence) algorithms for additional features such as the platform monitoring the data communications involving the first type of user to assist with an outcome or advancement of the effectiveness of the communication such as by generating, providing and/or suggesting insights via the GUI to one of the users (e.g., first type of user) as one or more data insights that are contextually relevant to information or context discerned via the monitoring of the communication. This may involve, for example, CPU processing circuitry of the platform responding to monitoring of the communication by transcribing words used in the communication and/or recognizing aspects of the communications. For example, the recognized aspects of a communication may be or relate to: identities of the users, specific names of personnel or entities or topics, and/or combinations of such aspects that are associated with data or reasons in a client-entity profile for taking specific action in connection with providing (or offering to provide via the GUI) an elevated-video experience. In one more-specific example, the platform may utilize an ML/AI algorithm to learn from previous (e.g., GUI-related) elevated-video experiences for what types and involved aspects of communications an elevated-video experience might be offered; such as switching from a less-personalized communication channel (e.g., chat), to one or more more-personalized communication channels that may involve a highly-personalized video channel (e.g., with face-to-face communications and/or camera-control access to share selected content as described in connection with the example herein).

Further aspects of the present disclosure are directed to systems and methods that implement trained ML/AI processing to further contemplate other types of signal data that may be collected through various host applications/services (e.g., pertaining to a software platform). For instance, application of trained ML/AI processing (e.g., one or more trained machine learning models) may be adapted to evaluate data sources integrated into an exemplary software platform (e.g., communications platform such as 8×8 Work, and omni-channel orchestration of data points that include native data sources as well integrated third-party endpoints (e.g., third-party integrations including CRM tools). Contextual data may be derived from any data point individually or in aggregation including historical signal data or current signal data (e.g., an ongoing communication such as a video call, electronic meeting, etc.). For example, historical signal data collected from prior user communications may be combined with current user-specific signal data, device-specific signal data, etc., during an electronic meeting to generate and surface contextually relevant data insights for a user (e.g., agent assisting a customer). This unique and comprehensive analysis of big data managed through a communication platform enables provision of rich and contextually relevant data insights tailored for a specific purpose (e.g., enhance user communication such as agents/customers in an elevated video communication). Exemplary signal data analysis may further be utilized to yield determinations as to how (and/or when) to generate updated analytics (in real-time or near real-time) and/or reporting, as well as when and how often to present data insights and/or suggestions. For example, it may be important to properly evaluate a state of communication and identify contextually relevant data within an ongoing electronic meeting (e.g., dependent on user's sentiment, topic of conversation, content being presented, user attendance, etc.) relative to historical data and/or predicted patterns of users, which may help to determine not only the correct data to surface but when that data would be most beneficial to the participants. In further examples, signal data may be analyzed to determine the next steps or actions to be performed to continue communication and user engagement across an omni-channel software platform. As non-limiting examples, this may include automatically taking action to include other users in a communication, setting reminders, follow-up meetings, etc.

Non-limiting examples of signal data that may be collected and analyzed includes, but are not limited to, one or more of the following: device-specific signal data collected from operation of one or more user computing devices; user-specific signal data collected from specific tenants/user-accounts with respect to access to any of: devices, login to a distributed software platform, applications, services, etc.; application-specific data collected from usage of applications/services and associated endpoints (including third-party endpoints integrated within a software platform); and/or data collected from disparate software platforms that provide disparate types of access characteristics; or a combination thereof. Analysis of such types of signal data in an aggregate manner may be useful in helping generate contextually relevant determinations, data insights, etc. Analysis of exemplary signal data may comprise identifying correlations and relationships between different types of signal data specific to user usage of one or more software data platforms (e.g., communications platforms), where telemetric analysis may be applied to generate determinations with respect to a contextual state of user activity and with respect to different host application/services and associated endpoints at any point in time (historic, current, or predictive of future). Analysis of signal data, including user-specific signal data, should occur in compliance with user privacy regulations and policies.

In certain more-specific examples, one or more components are configured to manage application of one or more AI models to enhance processing described in the present disclosure. Trained AI processing is applicable to aid any type of determinative or predictive processing including specific processing operations described with respect to determinations, classification ranking/scoring and relevance ranking/scoring. An exemplary component for implementation trained AI processing may manage AI modeling including the creation, training, application, and updating of AI modeling. Trained AI processing may be adapted to execute specific determinations described herein including those for analyzing specific data and data sources of a software data platform (e.g., a communications platform) and/or generating insights for data augmentation. For instance, an AI model may be specifically trained and adapted for execution of processing operations pertaining to analyzing features and functionality of an XCaaS offering including those non-limiting examples described herein. Non-limiting examples of AI implementation include but are not limited to, one or more of the following: analyzing data (and/or metadata) associated with one or more software platforms including third-party integrations of features/functionalities, and/or analyzing data of past, current or scheduled communications, among other examples.

In one example, trained AI processing comprises a hybrid AI model (e.g., hybrid machine learning model) that is adapted and trained to execute a plurality of processing operations described in the present disclosure. In alternative examples, trained AI processing comprises a collective application of a plurality of trained AI models (e.g., more than one trained AI model) that are separately trained and managed to execute processing described herein (e.g., each model may be for specific tasks or subject matter). In alternative examples, the present disclosure extends to integrating third-party AI modeling and further adapting and customizing said AI modeling to work with specific data and data sources of an exemplary software platform. For example, a third-party AI model may be adapted to work with a communications platform including data, data sources, and integrations (e.g., APIs, web hooks, etc.) related to XCaaS features and functionality. In examples where a plurality of independently trained and managed AI models is implemented, downstream processing efficiency may be improved by an ordered application of trained AI models where processing results from earlier applied AI models that may be propagated to subsequently applied AI models. For example, a trained AI model may evaluate accesses, seeds, pinecones, indicators, external influences, weighting and the like, and derive data correlations to improve processing and efficiency. This may be utilized to adjust weighting and/or assessed risk levels based on the evaluations.

Non-limiting examples of supervised learning that may be applied comprise, but are not limited to, one or more of the following: nearest neighbor processing; naive Bayes classification processing; decision trees; linear regression; support vector machines (SVM) neural networks (e.g., convolutional neural network (CNN) or recurrent neural network (RNN)); and/or transformers, among other examples. Non-limiting examples of unsupervised learning that may be applied comprise, but are not limited to, one or more of the following: application of clustering processing including k-means for clustering problems, hierarchical clustering, mixture modeling, etc.; application of association rule learning; application of latent variable modeling; anomaly detection; and/or neural network processing, among other examples. Non-limiting examples of semi-supervised learning that may be applied comprise but are not limited to: assumption determination processing; generative modeling; low-density separation processing and graph-based method processing, among other examples. Non-limiting examples of reinforcement learning that may be applied comprise, but are not limited to, one or more of the following: value-based processing; policy-based processing; and/or, model-based processing, among other examples. Furthermore, a component for implementation of trained AI processing may be configured to apply a ranker to generate relevance scoring to assist with any processing determinations with respect to any relevance analysis, such as that described herein. Scoring for relevance (or importance) ranking may be based on individual relevance scoring metrics described herein or an aggregation of said scoring metrics. In some examples, where multiple relevance scoring metrics are utilized, a weighting may be applied that prioritizes one relevance scoring metric over another depending on the signal data collected and the specific determination being generated. Results of a relevance analysis may be finalized according to developer specifications. This may comprise a threshold analysis of results, where a threshold relevance score may be comparatively evaluated with one or more relevance scoring metrics generated from application of trained AI processing.

Further, aspects may integrate ML/AI modeling to correlate large volumes of data in a contextually relevant manner. This may be used not only for generation (and adaptation) of scoring for types of data to surface but also generation of decision points (e.g., alerting, access control, next steps, omni-channel engagement) as well as generation of data insights/suggestions, reporting, generation of knowledge base. In addition to broad applicability, approaches according to the present disclosure may be implemented as a scalable solution; e.g., a solution for a company in several different use cases are built (such as department-specific or user group-specific) to more effectively manage a software platform (e.g. communications platform).

As noted herein, video elevation as described herein may further be enhanced through generation, training, adaptation, and application of AI/ML modeling in numerous different instances. Connecting AI/ML modeling to expansive data sets and endpoints of a software communications platform creates practical applications that not only improve the processing efficiency of communications software platform through data collection, retention, and creation/augmentation (including creation of data insights), but further improve user experience and processing efficiency of resolving support issues between end users and agents, among other advantages. In some examples, one or more trained artificial intelligence models may be adapted to generate (and in some instances automatically capture) the annotation information based on at least the receipt of one or more actions initiated by the agent device, during the video call, via the GUI of the software communications platform. In further examples, AI modeling may be further trained to evaluate additional contextual information provided via the software communications platform to generate the annotation information, and wherein the additional contextual information comprises a transcription of the video call between the end user and the agent, and/or historical contextual information from previous use of the communications software platform by an end user entity associated with the end user device. This can enable richer contextual information for an electronic communication and beyond (e.g., follow-up actions, reporting, recommendations, etc.) In other examples, one or more trained artificial intelligence models to generate (and provide) one or more data insights for the agent device, including suggestions for capture of the annotation information. Among other things, this may enable an agent, via an agent device, to execute autonomy over the information being captured but quickly and efficiently confirm/capture important data in a timely manner, which is extremely important in a customer interaction, especially one where the customer is having technical issues. In one example, data insights may be provided to the agent device via the representation of the video call. However, because a software communications platform enables omni-channel communications, data insights may be sent directly to the agent device via another communication channel/modality such as chat, email, messaging (e.g., SMS messaging), etc. To generate the one or more data insights, one or more trained artificial intelligence models are trained to analyze receipt of action initiated by the agent device during the video call, and additional contextual information comprising one or more of: a transcription of the video call between the end user device and the agent device, and historical contextual information from previous use of the communications software platform by an end user entity associated with the end user device, and wherein the receiving of the data indicating a selection of one or more GUI control elements by the agent device occurs after the data insights are provided to the agent device. In even further examples, AI modeling may be created, trained, adapted, and applied to provide data insights, actions, recommendations, etc. after the conclusion video call so that a business relationship can be properly managed with an end user and its entity/business.

Consider an example where an agent is controlling a camera of an end user device during a video call or electronic meeting to display a leaking plumbing pipe in the home of the end user. In one instance, trained AI modeling may be adapted and applied to evaluate historical contextual information related to the end user/end user device, and associated entities. For instance, the end user may have tried to resolve this issue with no success by first chatting with a chatbot to find the right plumbing component and tools necessary to fix the leak. The end user may then have sent an SMS message with a similar query to support service to ask for a plumber to come and fix the leak with no timely response. Contextual data insights can be generated and provided to the agent to provide context for the call so that the agent is aware of customer's efforts and the difficulties with resolving the issue so the agent can optimize customer satisfaction during the call communication. Further, via a representation of the video call presented via a GUI, the agent may utilize its agent device to select GUI control elements to control features of the camera of the end user device, including panning, angle, direction, including when the agent is conversing with an end user during the video call. Trained AI modeling may be applied to analyze context of the video call/electronic meeting and generate data insights or automated actions (including creation and presentation of annotation information) based on analysis of the context of the video call. For instance, while selecting GUI control elements to zoom in on the leaking pipe being captured by the camera, the agent may ask the end user, “where is the pipe leaking from?” to which the end user may reply, “the middle of the pipe, near a coupling.” A transcription of the audio may be created in real-time (or near real-time) and analyzed by AI modeling to automatically generate annotation information to document the exact location of the leak based on the transcription of the call without the agent having to create an annotation.

Alternatively, annotation information can be presented as suggestion/data insight suggesting that the agent create annotation information to capture this detail. GUI control elements may be presented in the GUI of an application/service to enable toggling of functionality to automatically capture annotation information or alternatively present data insights or toggle any such functionality off. Continuing the example, the agent may be zooming in on the leaking pipe to get a closer look at the pipe, which includes a serial number for the pipe. Trained AI modeling may be adapted for image recognition and retrieval such that the serial number of the pipe can be identified and documented as annotation information. In further examples, trained AI modeling may be utilized to query the serial number and automatically retrieve additional details related to the pipe, which can be integrated (automatically) as annotation information (or data insights/suggestions for the agent). Moreover, trained AI modeling may be adapted and applied to create follow-up items, actions, during or after the video call based on contextual analysis. Say the end user states that it desires to have a plumber sent out to examine the leaking pipe, a support request may be automatically generated creating an appointment for the plumber to be sent to the address of the end user, which may include populating the support request with customer information retrieved from the profile of the end user. In further instances, a follow-up call or reminder for the same may be created so that the agent can follow-up with the end user after the created appointment. In further examples, reporting may be created to track events and progress of the repair of the pipe, which may then be made accessible to agents via the end user profile within the software communications platform.

In one embodiment, there may be one or more methods, apparatuses (e.g., systems, devices, etc.) comprising or involving aspects linked to or supported by one or more of the examples described herein.

In one case, there may be one or more methods and/or apparatuses comprising or involving aspects linked to or supported by or involving one or more changes (e.g., elevating) a data-communications experience by enabling video-related features such as permitting for remotely controlling aspects of the data communications experience by involving video from across a channel being used during the data-communications experience.

In one case, there may be one or more methods and/or apparatuses comprising or involving aspects linked to or supported by or involving one or more changes (e.g., elevating) a data-communications experience by way of an enhanced video-related aspect or control triggered by an operator involved with a GUI for the data-communications experience.

In one case, there may be one or more methods and/or apparatuses comprising or involving aspects linked to or supported by or involving one or more changes (e.g., elevating) a data-communications experience by way of an enhanced video-related aspect or control triggered by an ML/AI algorithm acting on a recognized aspect of the data-communications experience.

In one case, there may be one or more methods and/or apparatuses comprising or involving aspects linked to or supported by or involving one or more of the following data-communications platform features: recording of meetings; summarization (e.g., fully contextual); integrations of outputs from one or more ML/AI algorithms involved with analysis of the data communications; add in additional video streams (e.g., agent leg, video legs of other users); scheduler to include multiple users, schedule follow-up elevated video; inclusion of third-party integrations into elevated video (e.g., widgets, expanded features functionalities); quality management, speech analytics and/or sentiment analysis; feature flags (e.g., toggling on/off); customization of invites to meetings and/or current data communications; and an ability to aggregate interactions (stitch together timeline) to create comprehensive elevated video experience (e.g., asynchronously).

In one embodiment, the system implementing the described AI/ML/LLM capabilities may comprise a network of interconnected hardware components designed to support intensive computational tasks, data storage, and communication. Central to this system is a high-performance server infrastructure equipped with multi-core processors, such as those based on x86 or ARM architectures, capable of handling the parallel processing demands of AI model training and inference. These servers incorporate large-scale memory modules, such as DDR4 or DDR5 RAM, to enable efficient handling of real-time data streams and large datasets. Additionally, dedicated GPU (Graphics Processing Unit) or TPU (Tensor Processing Unit) accelerators are integrated into the system to optimize the execution of complex neural networks, supporting the execution of both supervised and unsupervised learning algorithms.

In another example, a distributed architecture may be employed to facilitate the robust processing requirements of omni-channel communication platforms. This architecture includes edge devices and data centers working in unison. Edge devices, equipped with embedded AI chips, enable localized data processing, reducing latency and preserving bandwidth by performing initial signal data analysis close to the source. Data centers, on the other hand, house extensive storage arrays, such as SSDs (Solid-State Drives) or NVMe (Non-Volatile Memory Express) systems, to store historical and current signal data. This distributed approach ensures scalability and reliability, particularly when processing vast amounts of signal data from multiple users and third-party integrations.

In one example, the system includes specialized networking hardware to manage the seamless transmission of data across various endpoints. High-speed routers, switches, and load balancers ensure uninterrupted connectivity and efficient routing of signal data to the AI processing components. These networking components are configured to support protocols like HTTPS, WebSocket, and custom API frameworks to enable real-time data exchange between the software platform, user devices, and third-party integrations. This hardware infrastructure is complemented by software-defined networking (SDN) technologies, which dynamically allocate resources and prioritize traffic to maintain optimal system performance.

In a further example, dedicated hardware security modules (HSMs) and encryption accelerators are implemented to ensure compliance with user privacy regulations and secure the integrity of data during processing and transmission. These components provide secure key management and encryption capabilities, protecting user-specific and device-specific signal data from unauthorized access. Integration of biometric authentication sensors on user devices further enhances security, enabling secure access to the software platform and ensuring that user-specific data remains protected.

In yet another embodiment, the system incorporates advanced monitoring and diagnostic tools built on IoT (Internet of Things) sensors and telemetry devices. These tools collect operational metrics from hardware components, including CPU utilization, GPU performance, memory usage, and network throughput. This data is fed into AI models to predict potential bottlenecks or failures, enabling proactive maintenance and ensuring continuous availability of the platform. Such hardware-based telemetry systems are crucial for maintaining the reliability and scalability of the AI/ML processing environment.

These hardware components collectively enable the seamless implementation of AI/ML/LLM capabilities as described, providing the computational power, storage capacity, and security measures necessary to support advanced analytics, contextual data insights, and omni-channel engagement across the communication software platform.

A system and/or communications platform, as described herein, may contain at least one or more hardware components (e.g., as described further herein) for carrying out actions, performing functions, and presenting a graphical user interface (GUI) (e.g., such as, but not limited to, those shown in figures described herein). For example, a customer communications management system may involve multiple components working together seamlessly.

The front end of communications platform may refer to the parts of the system that are visible to and interacted with by the user. It includes the user interface (UI), which may include graphical elements like buttons, forms, dashboards, and charts. These components may enable a user to perform tasks such as managing campaigns or viewing analytics. The front end is built using client-side technologies like HTML, CSS, and JavaScript, which run directly in the user's web browser or mobile application. Interactions with the interface may constitute one form of input into the communications platform, which may be used by the communications platform to generate output to other systems, the interface, and/or trigger functionality as described herein. The communications platform may have, for examples, a front end that includes a dashboard for managing customer interactions, chat interfaces customers see during engagements, communications control (e.g., call operation, communication queues, etc.) and analytics reports.

The back end, on the other hand, may power functionality of communications platform and handle behind-the-scenes processes. This may include server-side logic, which is written in programming languages like Python, Java, or Node.js, to process user requests, implement business logic, and deliver appropriate responses. Databases, such as MySQL, MongoDB, or PostgreSQL, may be utilized in storing and retrieving essential data, including user accounts, campaign details, and customer interaction histories. The back end may provide APIs (Application Programming Interfaces) that the front end calls to retrieve or send data. The back end may also encompass infrastructure, including servers, cloud services, and networking components, that ensures the system is functional, scalable, reliable, and secure. In the case of the communications platform, back-end functionality may include, but is not limited to, storing customer information, routing messages to and from customers, and processing analytics data for reporting.

The front end and back-end work may work together seamlessly to create a smooth and effective user experience. When a user interacts with the front end—such as sending a message to a customer—the front end may communicate with the back end to process the request. The back end may validate the message, route it appropriately (e.g., either through sub-systems and/or appropriate hardware architectures, as described herein, etc.), and update a database as needed. It may then send the result back to the front end, which may update the user interface to reflect the outcome.

The front end may be responsible for the visual elements and interactivity and may be built using web technologies. This may include HTML and CSS for structure and styling, JavaScript for dynamic updates and interactivity, and frameworks like React.js, Angular, or Vue.js for building modular interfaces. Design systems like Material-UI or Bootstrap may provide consistency. The GUI may also leverage micro-frontends, where each panel (e.g., “Assigned Queues” or “Voicemail Management”) is representative as an independent module within the communications platform or possibly even external to, but integrated with, the communications platform. To enable dynamic data updates, the front end may communicate with the back end through RESTful or GraphQL APIs.

The back end may handle data processing, communication routing, algorithm execution, business logic, database operations, and/or APIs powering the front end. It may be programmed in languages like Node.js, Python (with Django or Flask), Java (with Spring Boot), or Ruby (with Ruby on Rails). A microservices architecture may be employed, where each functionality-such as voicemail management or analytics-is an independent, deployable service. Databases like MySQL or PostgreSQL may be used for structured data, while NoSQL solutions like MongoDB or Redis may handle unstructured data. Middleware services may manage authentication, caching, and routing, while APIs may act as the communication layer between the front end and back end. The entire communications platform may be hosted on cloud platforms like AWS, Google Cloud, or Microsoft Azure, ensuring scalability, load balancing, and fault tolerance. Docker and Kubernetes may be used for containerization and deployment, and authentication services like OAuth or JWT may be used for secure access.

The front end may be accessed via user devices such as PCs, laptops, or tablets running modern web browsers like Chrome, Firefox, or Edge, with sufficient RAM (8GB+), modern processors, and fast internet connectivity. The back end may run on cloud servers hosted on virtual machines or containers. These servers may require multi-core CPUs, high-performance RAM (32GB+), SSDs for database operations, and robust networking hardware. Organizations preferring local hosting may use dedicated physical servers. Networking infrastructure includes API gateways, reverse proxies like Nginx, and load balancers to ensure efficient request handling and fault tolerance.

The implementation of a system and/or communications platform may have a robust hardware infrastructure to ensure scalability, reliability, and seamless integration of its cloud-based communication and contact center functionalities. The core of the system may require high-performance servers to host the platform's core processing capabilities, including virtual machine environments for the deployment of application instances, database management systems, and real-time communication protocols. These servers may support multi-threaded processing and high I/O throughput to accommodate concurrent user interactions and data processing demands. Redundant power supplies and network interfaces may be necessary to maintain fault tolerance and high availability.

The network infrastructure supporting communications platform may incorporate enterprise-grade routing and switching hardware capable of handling high-bandwidth, low-latency traffic to facilitate real-time communication features such as voice, video, and data exchange. This infrastructure would ideally include Quality of Service (QOS) mechanisms to prioritize time-sensitive packets, such as voice over IP (VOIP) and video conferencing data, ensuring optimal performance. Connectivity to cloud hosting providers or data centers must be provisioned with redundant pathways to safeguard against potential network disruptions.

User endpoints from another critical hardware component of the communications platform. These may include desk phones, which may be SIP-compatible devices with capabilities such as wideband audio, programmable function keys, and integration with contact center features. For users who rely on software-based communication, client devices such as desktops, laptops, tablets, and smartphones may be equipped with sufficient processing power, memory, and graphics capabilities to handle the application interfaces and multimedia requirements. Compatibility with external peripherals, such as headsets and webcams, may be used for optimal user experiences.

Storage systems for the communications platform may support high-speed read and write operations, particularly for call recordings, historical data, and analytics. These storage systems may benefit from scalable architecture, such as Network Attached Storage (NAS) or Storage Area Networks (SAN), utilizing solid-state drives (SSDs) to meet performance demands. Hardware security modules (HSMs) and firewalls are critical for ensuring data integrity, privacy, and compliance with regulatory standards such as GDPR or HIPAA.

The communications platform may also require environmental monitoring and cooling solutions within data centers to maintain optimal operating conditions for hardware components, ensuring reliability and longevity. These technical requirements highlight the complexity and precision necessary in deploying a communication platform, like that described herein, emphasizing the need for state-of-the-art hardware components that align with the demands of real-time, cloud-based communication systems.

The communications platform may contain at least one or more hardware components (e.g., as described further herein).

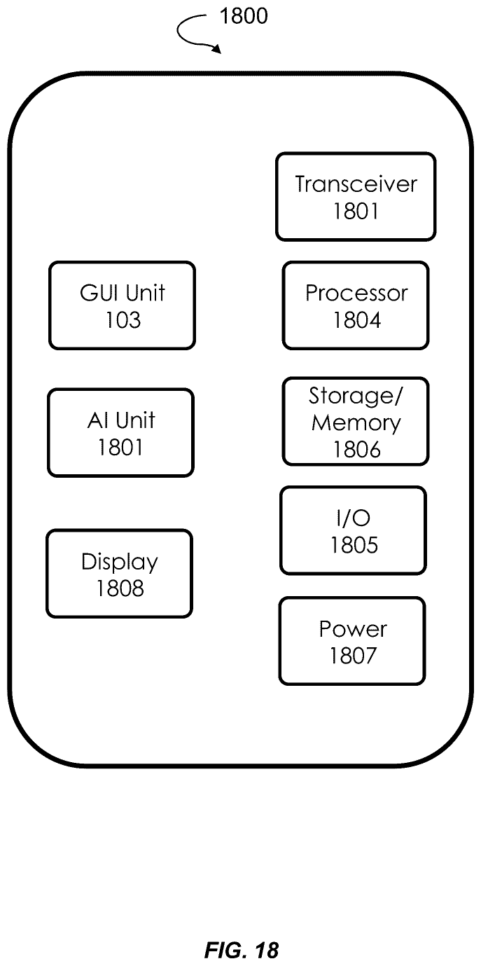

FIG. 18 is an example of a system computer (e.g., any device reference herein, such as but not limited to, communication platform, customer device, agent device, etc.). The computer may take any form, such as a server, a mobile device, networking equipment, communications equipment, phone switch, any device/functionality (e.g., as performed by an entity) described herein, or the like. As used herein, any reference to cloud computing, system computing, or any functionality may be performed on one or more computers. A computer 1800 may be described in regards to components, units, and/or functionality that may be performed. A unit or component may represent hardware and/or software that perform a specific function alone or in conjunction with other units. A computer 1800 may have one or more components, such as an AI processing unit 1801, a wireless and/or wired transceiver unit 1802, a GUI unit 1803, a central processing unit 1804, an I/O unit 1805, a storage/memory unit 1806, and/or a power unit 1807. A computer 1800 may have other hardware or software as is known in the art depending on the type of the device as disclosed herein (e.g., a smartphone may have a camera). For example, the compute may have input/output sensors (e.g., camera, microphone, keyboard, mouse, trackpad, etc.). For example, a computer 1800 may run software/application (e.g., modules, etc.) 1801 using the processor 1804 (e.g. processor) operatively coupled to the storage/memory (e.g. RAM, hard drive, etc.), the transceiver 1102 (e.g. WIFI radio, cellular radio, networking interface, etc.), and a power component 1807. In one example, a computer is a user equipment (UE) and sends a message to a communications platform (e.g., with a front end and a back end, where both the front end and back end each have one or more computers associated with it such that their respective functionalities may be performed); the UE may receive a response message from the communications platform, and display a GUI designed to receive commands and/or other user input into the UE. The commands/input may then be sent as a second message to the communications platform. This process may continue as needed (e.g., as described herein, according to one or more techniques, embodiments, examples, etc.).

In one case, a customer device is a computer. In one case an agent device is a computer. In one case, a communications platform is a computer system.

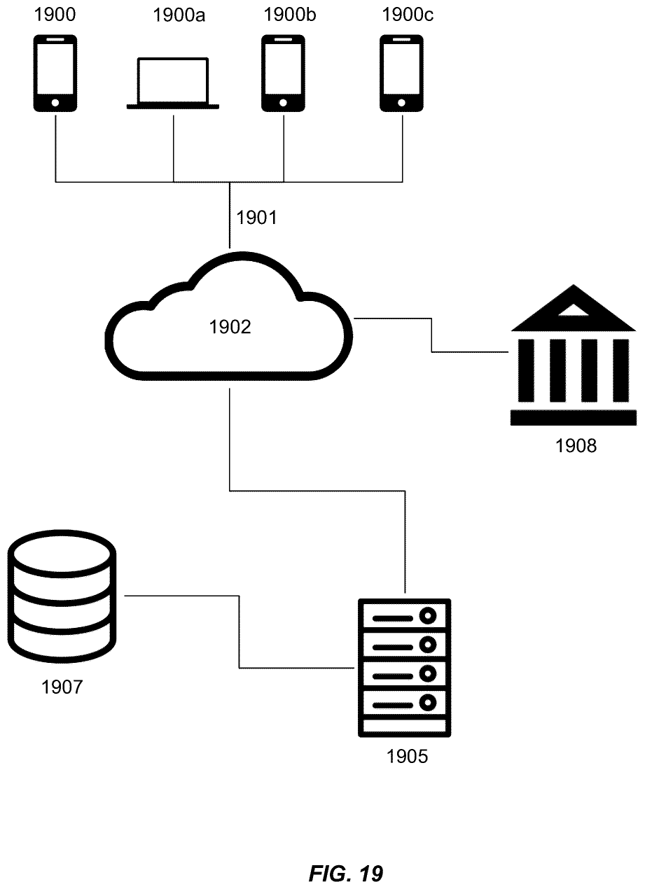

FIG. 19 illustrates an example of a network architecture of a communications platform. The network may have one or more devices for users 1900a-c that communicate 1901 with a network 1902 (e.g., Internet) in a wireless or wired manner. As an example, a user device 1900 may be a user equipment (UE), a mobile station, a fixed or mobile subscriber unit, a pager, a cellular telephone, a personal digital assistant (PDA), a smartphone, a laptop, a netbook, a tablet, a personal computer, a wireless sensor, consumer electronics, a television, and the like. A UE 1900 may be capable of receiving input and providing output to a user operating the UE 1900. The UE 1900 may also send and receive information through a local area network or the internet. The UE 1900 may connect to the internet, which in turn may access a website/service/platform hosted by a server 1905 connected by a wired/wireless connection 1903. The server 1905 and database 1907 may represent the infrastructure that facilitates one or more aspects of the communications platform. In one configuration, the infrastructure may comprise a backend and/or frontend hosted through a self-hosted or remote hosted service of several database and/or servers protected by a firewall and accessed through a load balancer. The communications platform may have elements that operate on cloud infrastructure such as Amazon® Web Services (AWS), Microsoft® Azure, or the like. The communications platform may provide Software as a Service (SaaS) or Software as a Product (SaaP). The server 1905 may provide service through a website/service/platform/application programming interface (API). The server 1905 may be connected 1906 to a database 1907 that stores information related to input from any of the UEs 1900, 1900a-c. In an alternative configuration, there may be more than one database 1907 and/or the database(s) may be part of the server 1905. The server 1905 may also interact with a payment service 1908 as discussed herein.

As described herein, there may be a process comprising of one or more steps, where one or more steps may have their order changes, be optional, simultaneous, and/or omitted depending on a given use case. It is intended that this process may include one or more elements from the embodiments/examples disclosed herein, even though such inclusion may not be explicit.

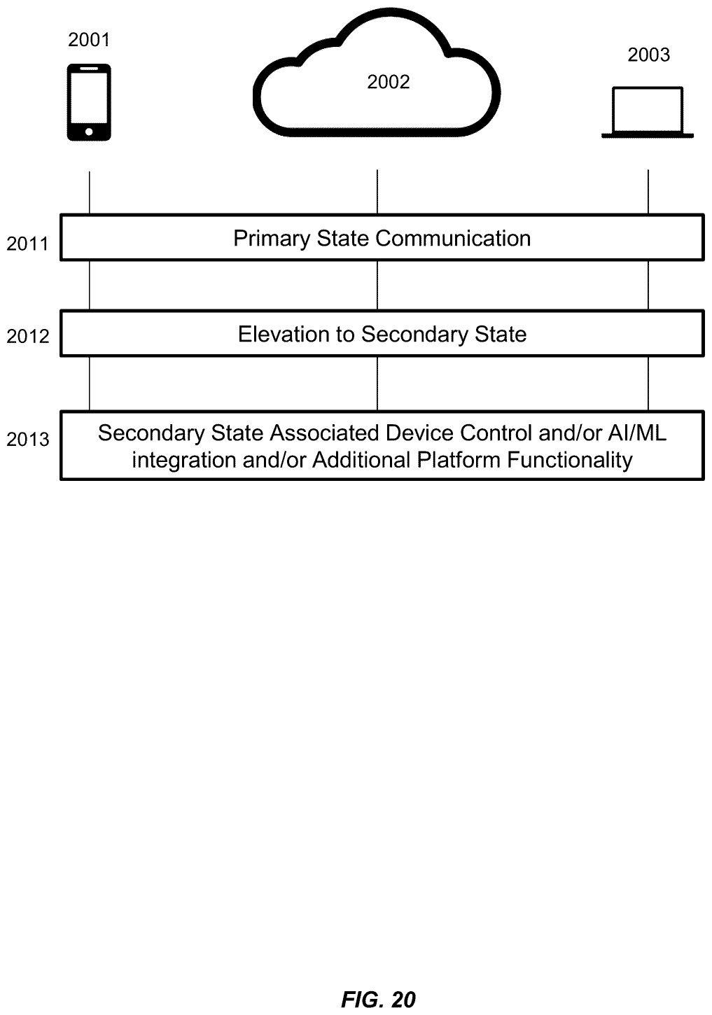

Generally, an exemplary process may center around the transition from a primary state of communication to a secondary state of communication, and the actions taken after such a transition. FIG. 20 illustrates an example process based on one or more embodiments herein. There may be an end-user device at 2001, a communications platform at 2002, and/or an agent device at 2003. Initially, at 2011, the end user device 2001 may be engaged in a primary state of communication with the end-user device 2001 via the communications platform 2002. In one instance, the communications platform 2002 may facilitate all steps, embodiment, and examples as described herein. At 2012, communication may be elevated to a secondary state. At 2013, after the transition of the communication to a secondary state, device control (e.g., of the end-user device 2001) may be exercised, annotations may be made, and/or the platform may provide actionable insights (e.g., as described herein).

In view of the general example of FIG. 20, a more detailed non-limiting example may be understood as follows. One embodiment of the computer-implemented method may begin by sending a video elevation request designed to transition an electronic communication between an end user device and an agent device from an initial state to a video call state executed via a software communications platform. In one possible approach, the initial state could be a voice call or alternatively an electronic chat, message, or email, and the request configures the communication to be elevated into a full video call. Following this, the method may involve launching the video call through the communications platform, thereby connecting the end user device and the agent device in a real-time session.

During the call, the process may optionally provide the agent device with control over the end user device's camera within a representation of the video call displayed via a graphical user interface (GUI) on the platform. For instance, this control might be established by transmitting a permission request to the end user device; once permission is accepted, the system displays a view from the camera and activates GUI control features that enable the agent device to manipulate the camera's operation. Alternatively, the GUI may directly present control elements that allow the agent device to adjust the camera's view, such as panning the viewable area or modifying the angle and direction relative to objects visible on the screen.

In parallel with camera control, the method may capture annotation information for one or more objects visible via the camera. This annotation information can be generated based on actions initiated by the agent device through selections on the GUI. For example, if the agent device selects certain GUI control elements, the system might analyze this input to generate annotations, which could include outputs like a screenshot, a video clip, descriptive tags, or geo-locational markers for the objects. In some embodiments, one or more trained artificial intelligence models may be applied to assist in this process. These AI models can analyze the actions taken by the agent during the video call—potentially alongside additional contextual information such as transcriptions of the call or historical data from previous interactions—to provide data insights and suggestions for capturing the annotation information. In such scenarios, the receipt of GUI input by the agent device might occur after these data insights are provided, or alternatively, the AI models may directly generate the annotation information by evaluating both the agent's inputs and the contextual data.

Overall, one or more methods outlined herein presents a series of potential actions-from elevating a communication into a video call, launching the call, and providing dynamic camera control via a GUI, to capturing detailed annotation information using both direct user input and advanced AI analysis-all of which work in concert to enhance the interactive experience on the software communications platform.

In view of the general example of FIG. 20, a more detailed non-limiting example may be understood as follows. For example, in one case there may be a system that comprises at least one processor; and a memory, operatively connected with the at least one processor, storing computer-executable instructions that, when executed by the at least one processor, causes the at least one processor to execute instructions for a method, as described herein. In one instance, there may be a step for sending a video elevation request configured to transfer an electronic communication of a software communications platform, between an end user device and an agent device, from a first state to a second state, wherein the second state is a video call executed via the software communications platform (e.g., system). There may be a step for launching, via the software communications platform, the video call that involves the end user device and the agent device. There may be step for providing the agent device with control over a camera of the end user device in a representation of the video call via a graphical user interface (GUI) of the software communications platform. There may be a step for capturing, in the representation of the video call presented via the software communications platform, annotation information for one or more objects viewable via the camera (e.g. of the end user device, wherein the video is sent to the platform and subsequently transferred to the agent device) based on a receipt of one or more actions initiated by the agent device that are received via the GUI of the software communications platform while the agent device has control over the camera of the end user device. In one instance, the first state of the electronic communication is a voice call between the end user device and the agent device. In one instance, the electronic communication is between the end user device and the agent device, and the first state of the electronic communication is one of an electronic chat, an electronic message, or an email. In one instance, the providing of the agent device with control over the camera of the end user device during the video call further comprises transmitting a permission request to the end user device to enable the end user device to accept a permission for the agent device to control the camera during the video call, in response to receiving acceptance of the permission, displaying a view from the camera in the representation of the video call and activating, in the representation of the video call, GUI feature functionality for the agent device to control the camera. In one instance, the providing further comprises providing, in the representation of the video call via the GUI of the software communications platform, GUI control elements enabling control over the camera of the user device by the agent device, and wherein the capturing further comprises receiving data indicating a selection of one or more GUI control elements by the agent device in the representation of the video call, and generating the annotation information based on an analysis of the data indicating the selection of the one or more GUI control elements by the agent device. In one instance, the GUI control elements are configured to enable panning of a viewable area of the camera including the one or more objects, and wherein the capturing further comprises receiving data indicating a selection of one or more GUI control elements for adjusting an angle and a direction of a view of the camera relative to the one or more objects. In one instance, the GUI control elements further comprise GUI elements control configured to enable the agent device, via the representation of the video call, to generate one or more of: a screenshot of the one or more objects, a video clip of the one or more objects; a description tag for the one or more objects, and a geo-locational marker for the one or more objects. In one instance, there may be steps for applying one or more trained artificial intelligence models to generate one or more data insights for the agent device, including suggestions for capture of the annotation information, and providing the agent device with the one or more data insights, wherein to generate the one or more data insights, the one or more trained artificial intelligence models are trained to analyze receipt of action initiated by the agent device during the video call, and additional contextual information comprising one or more of: a transcription of the video call between the end user device and the agent device, and historical contextual information from previous use of the communications software platform by the end user device (or organizational including interactions with agents), and wherein the receiving of the data indicating a selection of one or more GUI control elements by the agent device occurs after the data insights are provided to the agent device. In one instance, the capturing further comprises applying one or more trained artificial intelligence models to generate the annotation information based on the receipt of one or more actions initiated by the agent device, during the video call, via the GUI of the software communications platform. In one instance, the one or more trained artificial intelligence models are further trained to evaluate additional contextual information provided via the software communications platform to generate the annotation information, and wherein the additional contextual information comprises a transcription of the video call between the end user and the agent, or historical contextual information from previous use of the communications software platform by an end user entity associated with the end user device.

In view of the general example of FIG. 20, a more detailed non-limiting example may be understood as follows. Initially, there may be ongoing communications in a primary state (e.g., a voice or VoIP call, chat, etc.) facilitated by the communications platform between an agent device and an end user device (e.g., customer device). A communications platform may perform a method that begins by receiving a video elevation indication from an agent device. Based on this indication (e.g., the agent selects to elevate communications channel to video via a GUI, as described herein), the platform may send a message—potentially an SMS—that includes a video call link to a customer device. The platform may then receive a video call (e.g., secondary state) request associated with that link and establish a video call between the customer device and the agent device (e.g., the customer clicks the link, which causes the customer device to send a message to the platform indicating that it can begin the video call, which may include additional technical steps to facilitate the call between the customer device and agent device, such as sending instructions to an application or GUI of teach device to launch the video call). During the call, the platform may receive annotation information via the agent device and present that annotation information to the customer device (e.g., the annotation information may be annotations made to a screen shot, or live video, originating from the customer device's camera). Additionally, the platform may analyze contextual information using one or more artificial intelligence models and send one or more insight messages to the agent device during the call based on this analysis (e.g., the contextual information may be from the video call or from historical data stored at the platform or an accessible database). The call may be ended, after at least one insight message is sent, upon receiving a termination message from either the customer device or the agent device. Subsequently, the platform may summarize the video call into a record and send this record to a customer resource management system. Optionally, the message sent to the customer device may include a consent requirement with instructions for presenting a prompt for consent, whereby a consent affirmation is received before establishing the video call. The contextual information analyzed by the platform may include data such as chat history, call history, or previously collected customer information; it may also include real-time data gathered from the call, such as a live transcript and a machine learning analysis of live video content. Furthermore, contextual information may be drawn from both the communications platform and the customer resource management system. The platform may also receive a control message from the agent device that is then sent to the customer device, and this control message may alter a function of the customer device—such as selecting a specific camera from among several, adjusting the operating state of a light, or modifying the camera's zoom level. In some cases, the annotation information may be augmented reality annotations that are fixed to an object viewable during the video call. Throughout these steps, the method may be executed by a single communications platform operatively connected to both the agent device and the customer device.

AI/ML integration may enhance the embodiment(s)/example(s) described herein by enabling advanced, context-aware features that improve both the user experience and the efficiency of communications. For example, machine learning models can analyze historical data—such as previous interactions, user preferences, and communication patterns—to tailor the elevated video experience for each individual interaction. In one scenario, an ML model might process past communication transcripts to identify recurring issues or frequently asked questions. During a live session, the system could then automatically generate annotation suggestions or prompts for the agent, ensuring that critical details (such as product serial numbers or issue descriptions) are captured accurately and efficiently.

Moreover, natural language processing (NLP) capabilities can be employed to transcribe and analyze the audio from the elevated video session in real-time. This allows the system to extract key phrases and sentiments, which can be used to adjust the conversation dynamically—for instance, by suggesting follow-up questions or identifying moments when additional support might be needed. If an agent is assisting a customer with a technical problem, the system might detect customer frustration or confusion through sentiment analysis, triggering the display of additional data insights or relevant troubleshooting steps directly in the agent's user interface.

Another enhancement provided by AI/ML is the automation of camera control based on visual cues. For instance, a computer vision model can recognize specific objects within the video stream—such as a component that, based on historical data or configured indication, may be the cause of the problem, may be damaged equipment, etc.—and automatically adjust the camera to zoom in on the relevant area and/or annotated the video stream to highlight this component (e.g., an IT support for an internet service provider may have an elevated video call where a loose connection is annotated or presented as text as a common issue). This not only improves the clarity of the communication but also reduces the cognitive load on the agent, who can then focus on providing assistance rather than manually controlling the camera. Additionally, the AI/ML system can store these visual annotations along with metadata, such as geolocation or timestamp information, for later analysis and reporting.

In a further example, the system might employ a hybrid machine learning model that combines supervised and unsupervised learning techniques to continuously improve its recommendations over time. As the platform gathers more data from various interactions, the AI models can learn which data insights are most valuable to agents in different contexts. For instance, after multiple customer interactions about a common technical issue, the system could automatically generate a knowledge base article, suggest an appropriate troubleshooting protocol, or even trigger the scheduling of a follow-up session. This dynamic, adaptive behavior streamlines operations in contact centers and similar environments by reducing response times and improving overall communication quality.

By leveraging AI/ML, the platform is not only able to provide a more personalized and efficient elevated video experience but also to transform raw data into actionable insights that can drive improved customer satisfaction and operational efficiency across a variety of communication channels.

In view of any example or embodiment described herein, it may be understood that there may be a process implemented by a computer (e.g., including at least memory, a processor, and/or a transceiver for communications) that transforms existing electronic communications (such as voice calls, chats, emails, or messages) into video calls or electronic meetings within a unified software communications platform. By “elevating” a communication to video, users (e.g., agents and customers) gain enhanced features such as remote camera control, in-call annotation, screenshot capture, and AI-driven data insights. This computer may have video elevation functionality, such as a sub-module of a larger piece of software, that enables a seamless transition from non-video channels to video calls or meetings through the orchestration of multiple hardware components, improving interaction and collaboration. This computer may have an adaptive user interface that offers controls for remote camera manipulation (panning, focusing) and annotation (screenshots, tagging, notes, geo-locational markers), streamlining data capture during live video sessions. This computer may have integration/inclusion of AI/ML, which leverages one or more models to generate insights, recommend actions, and automate data capture or annotation, enhancing efficiency and user experience. This computer may have omni-channel communications, that support multiple communication channels (e.g., voice, chat, messaging, email) within a single platform, creating a cohesive environment for both agents and end users. This computer may orchestrate data analysis and collection regarding contextual data throughout the communication process, enabling better post-call follow-up, recommendations, and ongoing relationship management. Technical advantages of this computer may include reducing processing complexity and latency, improving resource usage, and enhancing usability via an integrated set of software tools and services, driving more efficient and engaging support or collaboration sessions.

In view of the any example or embodiment described herein, AI/ML may be a component of the communications platform. AI/ML modeling may enhance video elevation sessions, particularly when an agent remotely controls an end user's camera during a video call. The platform may automatically capture annotations by analyzing real-time transcriptions and other contextual data, which allows it to suggest or document key details—such as key aspects that can only be gained by video of a problem during a trouble shooting session that requires component specifics to properly resolve—thereby reducing the need for manual data entry by the agent and/or providing enhanced processing and knowledge base to the agent or directly to the customer. Additionally, by leveraging historical data from past interactions like chatbot queries and messages, the platform provides agents with richer context during calls, ultimately improving troubleshooting efficiency and the overall support experience. The platform further offers integrated GUI controls that enable agents to adjust the customer device, such as panning, lighting, camera selection, zooming, or changing camera types—while simultaneously delivering AI-generated insights through multiple communication channels, including chat, email, or SMS. Beyond real-time assistance, the system can also automate actions such as scheduling service appointments, creating support tickets, or generating reminders based on the context of the conversation, and it can retrieve detailed information, like a pipe's serial number, for immediate documentation or follow-up. Overall, these AI/ML enhancements streamline agent workflows, reduce manual tasks, and improve user satisfaction by providing intelligent, context-aware support during and after elevated video calls.

In an embodiment(s), there may be a communications platform that can provide an elevated video experience, wherein various elements of the embodiment may be implemented optionally and in any suitable combination. In one example, the platform includes a communications module that establishes omni-channel communications among multiple user devices, together with a video elevation module that launches an elevated video experience in response to a trigger event. In this elevated experience, a user interface (UI) is provided which displays one or more graphical user interface (GUI) controls that enable, for example, a first user (such as an agent) to remotely control the camera functionality of a second user (such as a customer). Optionally, a data integration module may be included to incorporate contextual data fields into the elevated video experience, thereby enriching the user experience and improving processing efficiency. In certain embodiments, the GUI controls may include selectable features for adjusting the camera functions on the second user's device. Such adjustments could involve panning, zooming, rotating, capturing still images, recording video clips, and generating annotation information. Additionally, a machine learning (ML) module may be optionally incorporated to analyze historical communications data along with current communication signals. This analysis can yield contextually relevant data insights that are subsequently displayed via the elevated video experience UI. The embodiment(s) also provides a method for delivering an elevated video experience within a data communications system. In one approach, the method involves initiating a communication between a first user and a second user over a first communication channel, followed by generating and transmitting an invitation for an elevated video experience. This embodiment, which may include customizable UI elements and contextual data fields, is sent to the second user, and upon receiving an acceptance, the system automatically launches an elevated video experience over a second communication channel that incorporates video functionality. The elevated experience further includes a UI that provides GUI controls enabling the first user to remotely control the camera functionality of the second user's device. In some embodiments, the communication may switch from the initial channel to the elevated video channel, and the method may further include the optional employment of a machine learning module to analyze historical and real-time communication data, generating and displaying data insights and recommendations to the first user. Moreover, the embodiment includes the automatic generation of annotation information, wherein audio from the elevated video experience is transcribed and analyzed to extract contextual data. This annotation information can then be stored for subsequent reporting and follow-up actions. The platform may be further integrated into environments such as contact centers or unified communications as a service (UCaaS) platforms, where the elevated video experience is accessed via a unified workspace—such as an Agent Workspace or Supervisor Workspace. Optionally, a scheduling module may also be provided to initiate and schedule multiple iterations of elevated video communications with one or more users, based on contextual communication requirements. In another aspect, a non-transitory computer-readable medium may store instructions that, when executed by a processor, perform operations including receiving an invitation for an elevated video experience (which may include selectable consent options and customizable UI elements), displaying an interface to a second user, receiving an acceptance, and automatically launching the elevated video session with integrated video and remote camera control features. Additionally, one or more machine learning models may be employed to analyze both historical and current communication data and to generate contextually relevant data insights, which are then displayed to the first user. Each of the described elements—such as the various modules, GUI controls, machine learning integrations, and scheduling functions—may be implemented independently or in combination with one another, so that the overall system, method, and computer-readable medium are adaptable to different implementations and environments according to the needs of the particular application.

As described herein, a higher layer may refer to one or more layers in a protocol stack, or a specific sublayer within the protocol stack. The protocol stack may comprise of one or more layers in a given device or system, where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of Internet Protocol (IP) or the like. For example, Layer 2 may comprise of Medium Access Control (MAC) or the like. For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein. In one example, a base station may be distributed (e.g., different units that address or include different functions/layers/protocols/hardware/etc.; a first unit, second unit, etc.).

Although features and elements are described herein in particular combinations (e.g., embodiments, methods, examples, etc.), one of ordinary skill in the art will appreciate that each feature or element may be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. A symbol ‘/’ (e.g., forward slash) may be used herein to represent ‘and/or’, where for example, ‘A/B’ may imply ‘A and/or B’. As used herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’ or indicate that something “does happen” or “may happen”. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a computer, server, communications platform, UE, terminal, base station, network device, phone device, or the like

As disclosed herein, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A symbol ‘/’ (e.g., forward slash) as used herein, unless otherwise indicated, represents ‘and/or’, where for example, ‘A/B’ may imply ‘A and/or B’.

As described herein, “etc.” may refer to etcetera, which is intended to reference any other like element in a list, or reference some other element disclosed herein. For example, if a list has “a, b, c, etc.” and another list disclosed herein discloses “a, b, c, d, e” then it is intended that the “etc.” may refer to at least “d, e” or “etc.” may generally refer to other letters in the alphabet.

As described herein, “at least one of” may be interchangeable with “one or more of”.

As described herein, reference of a configuration may mean that at some point a device may receive a message that includes configuration information. In one instance, the device may provide feedback after having received it. In one instance, the device may request the message. In one instance, the message may be unrequested.

What is claimed is:

1. A computer-implemented method comprising:
sending a video elevation request configured to transfer an electronic communication of a software communications platform, between an end user device and an agent device, from a first state to a second state being a video call executed via the software communications platform;
launching, via the software communications platform, the video call that comprises the end user device and the agent device;
providing the agent device with control over a camera of the end user device in a representation of the video call via a graphical user interface (GUI) of the software communications platform; and
capturing, in the representation of the video call presented via the software communications platform, annotation information for one or more objects viewable via the camera based on a receipt of one or more actions initiated by the agent device that are received via the GUI of the software communications platform while the agent device has control over the camera of the end user device.

2. The computer-implemented method of claim 1, wherein the first state of the electronic communication is a voice call between the end user device and the agent device.

3. The computer-implemented method of claim 1, wherein the electronic communication is between the end user device and the agent device, and the first state of the electronic communication is one of an electronic chat, an electronic message, or an email.

4. The computer-implemented method of claim 1, wherein the providing of the agent device with control over the camera of the end user device during the video call comprises transmitting a permission request to the end user device to enable the end user device to accept a permission for the agent device to control the camera during the video call, in response to receiving acceptance of the permission, displaying a view from the camera in the representation of the video call and activating, in the representation of the video call, GUI feature functionality for the agent device to control the camera.

5. The computer-implemented method of claim 1, wherein the providing comprises providing, in the representation of the video call via the GUI of the software communications platform, GUI control elements enabling control over the camera of the end user device by the agent device, and wherein the capturing further comprises receiving data indicating a selection of one or more GUI control elements by the agent device in the representation of the video call, and generating the annotation information based on an analysis of the data indicating the selection of the one or more GUI control elements by the agent device.

6. The computer-implemented method of claim 5, wherein the GUI control elements are configured to enable panning of a viewable area of the camera including the one or more objects, and wherein the capturing further comprises receiving data indicating a selection of one or more GUI control elements for adjusting an angle and a direction of a view of the camera relative to the one or more objects.

7. The computer-implemented method of claim 6, wherein the GUI control elements further comprise GUI elements control configured to enable the agent device, via the representation of the video call, to generate one or more of: a screenshot of the one or more objects, a video clip of the one or more objects; a description tag for the one or more objects, and a geo-locational marker for the one or more objects.

8. The computer-implemented method of claim 5, further comprising: applying one or more trained artificial intelligence models to generate one or more data insights for the agent device, including suggestions for capture of the annotation information, and providing the agent device with the one or more data insights, wherein to generate the one or more data insights, the one or more trained artificial intelligence models are trained to analyze receipt of action initiated by the agent device during the video call, and additional contextual information comprising one or more of: a transcription of the video call between the end user device and the agent device, and historical contextual information from previous use of the communications software platform by an end user entity associated with the end user device, and wherein the receiving of the data indicating a selection of one or more GUI control elements by the agent device occurs after the data insights are provided to the agent device.

9. The computer-implemented method of claim 5, wherein the capturing further comprises applying one or more trained artificial intelligence models to generate the annotation information based on the receipt of one or more actions initiated by the agent device, during the video call, via the GUI of the software communications platform.

10. The computer-implemented method of claim 9, wherein the one or more trained artificial intelligence models are further trained to evaluate additional contextual information provided via the software communications platform to generate the annotation information, and wherein the additional contextual information comprises a transcription of the video call between the end user device and the agent device, or historical contextual information from previous use of the communications software platform by an end user entity associated with the end user device.

11. A system comprising:
at least one processor; and
a memory, operatively connected with the at least one processor, storing computer-executable instructions that, when executed by the at least one processor, causes the at least one processor to execute a method that comprises:
sending a video elevation request configured to transfer an electronic communication of a software communications platform, between an end user device and an agent device, from a first state to a second state being a video call executed via the software communications platform,
launching, via the software communications platform, the video call that comprises the end user device and the agent device,
providing the agent device with control over a camera of the end user device in a representation of the video call via a graphical user interface (GUI) of the software communications platform, and
capturing, in the representation of the video call presented via the software communications platform, annotation information for one or more objects viewable via the camera based on a receipt of one or more actions initiated by the agent device that are received via the GUI of the software communications platform while the agent device has control over the camera of the end user device.

12. The system of claim 11, wherein the first state of the electronic communication is a voice call between the end user device and the agent device.

13. The system of claim 11, wherein the electronic communication is between the end user device and the agent device, and the first state of the electronic communication is one of an electronic chat, an electronic message, or an email.

14. The system of claim 11, wherein the providing of the agent device with control over the camera of the end user device during the video call further comprises transmitting a permission request to the end user device to enable the end user device to accept a permission for the agent device to control the camera during the video call, in response to receiving acceptance of the permission, displaying a view from the camera in the representation of the video call and activating, in the representation of the video call, GUI feature functionality for the agent device to control the camera.

15. The system of claim 11, wherein the providing further comprises providing, in the representation of the video call via the GUI of the software communications platform, GUI control elements enabling control over the camera of the end user device by the agent device, and wherein the capturing further comprises receiving data indicating a selection of one or more GUI control elements by the agent device in the representation of the video call, and generating the annotation information based on an analysis of the data indicating the selection of the one or more GUI control elements by the agent device.

16. The system of claim 15, wherein the GUI control elements are configured to enable panning of a viewable area of the camera including the one or more objects, and wherein the capturing further comprises receiving data indicating a selection of one or more GUI control elements for adjusting an angle and a direction of a view of the camera relative to the one or more objects.

17. The system of claim 16, wherein the GUI control elements further comprise GUI elements control configured to enable the agent device, via the representation of the video call, to generate one or more of: a screenshot of the one or more objects, a video clip of the one or more objects; a description tag for the one or more objects, and a geo-locational marker for the one or more objects.

18. The system of claim 15, where the method, executable by the at least one processor, further comprises: applying one or more trained artificial intelligence models to generate one or more data insights for the agent device, including suggestions for capture of the annotation information, and providing the agent device with the one or more data insights, wherein to generate the one or more data insights, the one or more trained artificial intelligence models are trained to analyze receipt of action initiated by the agent device during the video call, and additional contextual information comprising one or more of: a transcription of the video call between the end user device and the agent device, and historical contextual information from previous use of the communications software platform by the end user device, and wherein the receiving of the data indicating a selection of one or more GUI control elements by the agent device occurs after the data insights are provided to the agent device.

19. The system of claim 15, wherein the capturing further comprises applying one or more trained artificial intelligence models to generate the annotation information based on the receipt of one or more actions initiated by the agent device, during the video call, via the GUI of the software communications platform.

20. The system of claim 19, wherein the one or more trained artificial intelligence models are further trained to evaluate additional contextual information provided via the software communications platform to generate the annotation information, and wherein the additional contextual information comprises a transcription of the video call between the end user device and the agent device, or historical contextual information from previous use of the communications software platform by an end user entity associated with the end user device.
